(19) United States
(12) Patent Application Publication
(10) Pub. No.: US 2001/0044339 A1
(43) Pub. Date: Nov. 22, 2001

(54) Multi-player computer game, system and method

(76) Inventors: Angel Cordero, Brooklyn, NY (US); Nicholas M. Gonzalez, Hicksville, NY (US); Zhi Chen, Brooklyn, NY (US); Roger Campos, Brentwood, NY (US); Alfred Polanco, Glendale, NY (US); Daniel Melfi, Medford, NY (US); Nicodemo Schipano, San Bruno, CA (US); Mimoun Ouchaou, Freeport, NY (US)

Correspondence Address: Steven B. Pokotilow, Esq., Stroock & Stroock & Lavan LLP, 180 Maiden Lane, New York, NY, 10038, US

(21) Appl. No.: 09/789,834

(22) Filed: Feb. 20, 2001

Related U.S. Application Data
(60) Provisional application No. 60/183,318, filed on Feb. 17, 2000.

(51) Int. Cl. A63F 9/24; G06F 17/00; G06F 19/00

(52) U.S. Cl. 463/42; 463/40

(57) ABSTRACT

A multi-player computer game, system and development method that facilitate multi-player game play between and among various hardware platforms employing various operating systems and communication protocols. Multi-player game play between and among a plurality of players is now possible regardless of the hardware platform, communication protocol, and operating system of each of the player's computing devices. Players having different hardware and software configurations on their respective computing devices and communicating using various communication protocols may engage each other in multi-player game play. New application modules may be developed using a cross platform core and other foundation technologies to simplify and speed software development. Coding to a specific operating system or hardware device or protocol is no longer required.

### CROSS-REFERENCE TO RELATED APPLICATION

This application claims priority to Provisional Patent Application Ser. No. 60/183,318 filed on Feb. 17, 2000.

### FIELD OF THE INVENTION

The present invention relates to a multi-player and enhanced single-player computer game, system and method.

### BACKGROUND OF THE INVENTION

Computer game players constantly demand more challenging, visually and mentally exciting games. The games must hold a player's attention, draw a player back to the game again and again, and, facilitate multi-player game play. While certain types of multi-player game play are already possible (e.g., video arcade, side-by-side platform game play), the increasing sophistication of game players, the high-powered computing devices now available to the general public, and the quick Internet connection speeds now available, have all assisted in raising the standard for multi-player game play.

What has not yet been possible, is multi-player game play among players having different computing devices. For example, side-by-side gameplay requires that each player have a computing device compatible with the other player(s)' device(s). Even multi-player game play over the Internet requires that the multiple players have the same or at least compatible computing devices. The reason being that the software each player executes on his/her computing device must be compatible (i.e., must be able to bi-directionally communicate) with the software on the other players' devices.

Development of multi-player computer games is also currently time-consuming and expensive. One reason is the variety of hardware platforms currently available for multi-player game play. A multi-player game must be developed for each platform, with little cross-over or reuse of the application code from one platform to another. In addition, there is a significant learning curve for new software developers and even for experienced developers for hardware specific protocols, communication specifications, and new platform and development tools. Thus, current methods of developing multi-player computer games suffer from significant shortcomings.

### SUMMARY OF THE INVENTION

The present invention is directed to a multi-player computer game, system and development method.

The present invention provides special purpose software operable in connection with a processor of a client computing device to enable multi-player game play between and among different hardware platforms in any of a client/server, client/client, or client/client/server configurations. The present invention also provides special purpose software operable in connection with a processor of a server computer (or a plurality of server computers) to facilitate and manage multi-player game play over a network. The special purpose software on each of the client computer and server computer facilitates and manages communication between and among client computers (i.e., players) and server computers, regardless of the different hardware platforms and operating systems installed and operable on the various client computers to provide seamless connectivity among game players over a network. The amount of functionality provided by the client special purpose software and server special purpose software depends on a number of variables, such as, for example, type of multi-player game, number of players, connection configuration (e.g., client/client, etc.), game status (e.g., initiation, new players being added, players leaving, etc.).

In accordance with embodiments of the present invention, special purpose software operable in connection with a processor of a client computer for facilitating a multi-player computer game includes a plurality of components (e.g., modules, libraries, sub-systems, etc.) that facilitate communication between the client computer, server computer, and at least one other client computer having special purpose software installed thereon and operable in connection with a processor thereof. The components provided on the client computer depends on the level of multi-player functionality required for a particular multi-player game.

The client computer may comprise any computing device having a processor in connection with which special purpose software in accordance with the present invention may be operated. Such computing devices include, by way of non-limiting example, a personal computer (desktop, laptop), hand-held computing devices (e.g., personal digital assistants (PDAs) such as Palm®, BlackBerry®), computer game consoles (e.g., Sony Playstation® and Playstation 2, Sega Dreamcast®), cellular devices, and any other now known of hereafter developed computing device suitable for multi-player game play.

The present invention is also directed to a multi-player game system for facilitating multi-player computer game play over a network such as the Internet, for example. In accordance with this embodiment of the present invention, a server or a plurality of servers connectable to each other and to a network each include special purpose software operable in connection with a respective processor thereof for facilitating multi-player game play over that network among a plurality of client computers. A single server, a plurality of servers in a single location, or a plurality of geographically displaced servers may be provided, in accordance with various embodiments of the present invention. The server(s) provide various functionality to the client computers to facilitate multi-player game play. For example, the server(s) may maintain client (i.e., player) registration information, a logical map of the names and locations of all servers in the multi-player game system, resources which may be provided or made available to players during game play (but which may not be provided on the client computers for security or efficiency reasons), and various other functionality and information, as described in more detail below.

The server architecture of the inventive system provides flexibility, robustness, and performance enhancement, among other features and advantages. Typically, a server provides a category of functionality. In essence, server A provides functionality A. Within a networked environment, such as provided in accordance with the present invention, there exists a set of servers providing different functions; sometimes redundant (i.e., providing backup), sometimes completely separate and different. When servers of the same type (i.e., functionality) work together, they may provide a primary function, scalability, load balancing, quicker response and thus game performance, reliability, consistency, and may be capable of working together. Servers providing different functionality, on the other hand, may or may not collaborate to provide enhanced functionality.

The coordinated server configuration of the multi-player game system of the present invention advantageously provides a plurality of servers specifically designed and intended to cooperate with each other. That enhances the overall functionality of the inventive system. The servers provided in accordance with the present invention are complementary in services and can leverage some or all of each other's functionality. One of the key benefits of the present invention is provided in the server interoperability. Different applications can be developed to inter-operate with specific other applications. This is typically done by having engineers develop custom solutions for the applications to work together. However, a more advanced system like that of the present invention will provide a set of infrastructure tools, that allows various applications to work with various other applications without custom solutions (e.g., in a manner analogous to the “cut & paste” functionality provided by certain word processing programs yet usable for other applications outside of the word processing program). Server interoperability and functionality “sharing” in accordance with embodiments of the present invention may provide, by way of non-limiting example, service finding tools, common user registration, common authentication/security, common administration, open database, common protocols, common data formats, and the ability to operate with other systems.

The present invention is also directed to a method of software development that facilitates rapid development (i.e., software development) of new multi-player computer games by eliminating the need for a software engineer to write specific application code for each hardware platform, communication protocol, or operating system (OS). In accordance with this embodiment of the present invention, the software developer need only write software code specific for the multi-player game application, without concern for the hardware platform or OS upon which the game may be played, or which communication protocol will be utilized. In accordance with the present invention, a cross-platform core provides an interface between the specific application code and the operating system, hardware devices, and communication protocols of a computing device (which are generally different from one computing device to the next). The software developer thus need only code to the cross-platform core, which is always the same regardless of the hardware platform or operating system. The cross-platform core handles all communication between the application code and the client computing device, including communication between the client computing device and the server(s).

Other aspects, features, and functionality of the present invention will become apparent from the following detailed description, considered in conjunction with the accompanying drawing figures. It is to be understood, however, that the drawings, which are not to scale, are designed solely for the purpose of illustration and not as a definition of the limits of the invention, for which reference should be made to the appended claims.

### BRIEF DESCRIPTION OF THE DRAWINGS

In the drawing figures, which are not to scale, and which are merely illustrative, and wherein like reference characters denote similar elements throughout the several views:

FIGS. 1A-1G are schematic diagrams of various configurations of a multi-player computer game system constructed in accordance with embodiments of the present invention;

FIG. 2 is a schematic diagram of a plurality of servers arranged as a server cluster and provided as part of the multi-player computer game system of FIG. 1A;

FIG. 3 depicts various components provided by the special purpose software operable in connection with a processor of the client computing device in accordance with an embodiment of the present invention;

FIGS. 4A and 4 B depict the architecture of an application program, cross-platform core, and client computer hardware and operating system in accordance with embodiments of the present invention;

FIG. 5 depicts a protocol stack for the service layer of the cross-platform core depicted in FIG. 4A;

FIG. 6 depicts data flow for pass-through mode operation of the communication engine of the cross-platform core of the present invention;

FIG. 7 depicts data flow for synchronous mode operation of the communication engine of the cross-platform core of the present invention; and

FIGS. 8A-8C depict various embodiments of a matchmaker server in accordance with the present invention.

### DETAILED DESCRIPTION OF THE PRESENTLY PREFERRED EMBODIMENTS

The present invention is directed to multi-player computer game, system and development method that facilitate multi-player game play between and among various hardware platforms employing various operating systems and communication protocols. The terms “client”, “user”, and “player” are used interchangeably herein to denote a player of a multi-player computer game.

As used herein, the term “multi-player game” includes, by way of illustrative example and not limitation, a sports simulation game such as basketball, baseball, football, hockey, motor-cross, wrestling, car racing, skiing, and virtually any competition between at least two players, a fast twitch type game such as, for example, first-person shooter games, a turn-based game such as chess, card games, checkers, etc. in which two players take turns playing the game, a massively multi-player game in which hundreds or thousands of players simultaneously play the game.

The present invention provides special purpose software operable in connection with a processor of a client computing device to provide a multi-player computer game. The special purpose software provides an interface between an application module, which provides the functionality for a specific multi-player computer game, and the operating system and hardware devices and protocols of the client computing device. For example, the application module may provide functionality for a racer-type game, a sport-type game, etc. That application module communicates (i.e., bi-directional data exchange) with a cross-platform core that handles all communications between the application module and the computing device hardware, operating system, and protocol requirements. Thus, in accordance with the present invention, different application modules may be written to provide different multi-player game functionality, each of the different application modules being used in connection with the same cross-platform core to provide the various multi-player computer games.

The present invention also provides a system that facilitates multi-player game play between and among a plurality of players regardless of the different hardware platforms (i.e., different client computing devices) used by the various players. Each client computing device may be running the same multi-player application module (or code), and each client computing devices includes the cross-platform core. Each client computing device also communicates with a server having special purpose software to facilitate multi-player game play between and among the various players. The server provides various functionality that may enhance and/or supplement the functionality provided on the client computing device, and generally manages and facilitates multi-player game play over a network (e.g., the Internet, an intranet (LAN, WAN), or other network), such as modem-to-modem or direct link.

In accordance with the various embodiments of the present invention, multi-player game play between and among a plurality of players is now possible regardless of the hardware platform, communication protocol, and operating system of each of the player's computing devices. It is thus possible, in accordance with the present invention, for players having different hardware and software configurations on their respective computing devices and communicating using various communication protocols to engage each other in multi-player game play.

New application modules may be developed in accordance with the present invention using the cross-platform core and other foundation technologies of the present invention (e.g., communications engine, client/server architecture) to simplify and speed software development. Coding to a specific operating system or hardware device or protocol is no longer required. Thus, software development intervals are significantly reduced. In addition, the reusable cross-platform core does not require integration testing for each new application module, because the cross-platform core has previously been tested and integrated with a plurality of hardware platforms, operating systems and hardware devices and protocols.

The terms “computers”, “computing devices”, and “computing hardware” (and variations thereof) are used interchangeably herein and are intended to be broadly construed. Those terms are not intended to define or otherwise limit the scope or content of the present invention. A computer (either client or server) may include some or all of the following components: a processor (e.g., central processing unit (CPU)); memory (e.g., RAM, ROM); a harddrive unit (HDU); communications interface (e.g., modem, ROM BIOS); data input device (e.g., keyboard, mouse, etc.); and a display. The computer may also include additional known hardware components and devices (e.g., joystick); the configuration of the server and client computers not being a limitation of the present invention. They also includes general purpose software that provides for overall operation of the client or server computer, and may include the operating system, commercially available software (e.g., database), communications software, etc. A computer may be, by way of illustration only, a personal computer (desktop, laptop), hand-held computing devices (e.g., personal digital assistants (PDAs) such as Palm®, BlackBerry®), computer game consoles (e.g., Sony Playstation® and Playstation 2, Sega Dreamcast®), cellular devices, and any other now known of hereafter developed computing device suitable for multi-player game play.

The special purpose software provides the functionality of the present invention, may comprise one or more web-native modules, library files, etc., may reside on a client and/or server computer, and may utilize the general purpose software. It will be obvious to persons skilled in the art and from the disclosure provided herein that the programming language (C, C++, Java, etc.) used to create (i.e., code) the special purpose software is a routine matter of design choice. Thus, the present invention is not limited to a particular embodiment of the special purpose software as defined by the programming language used to code that software.

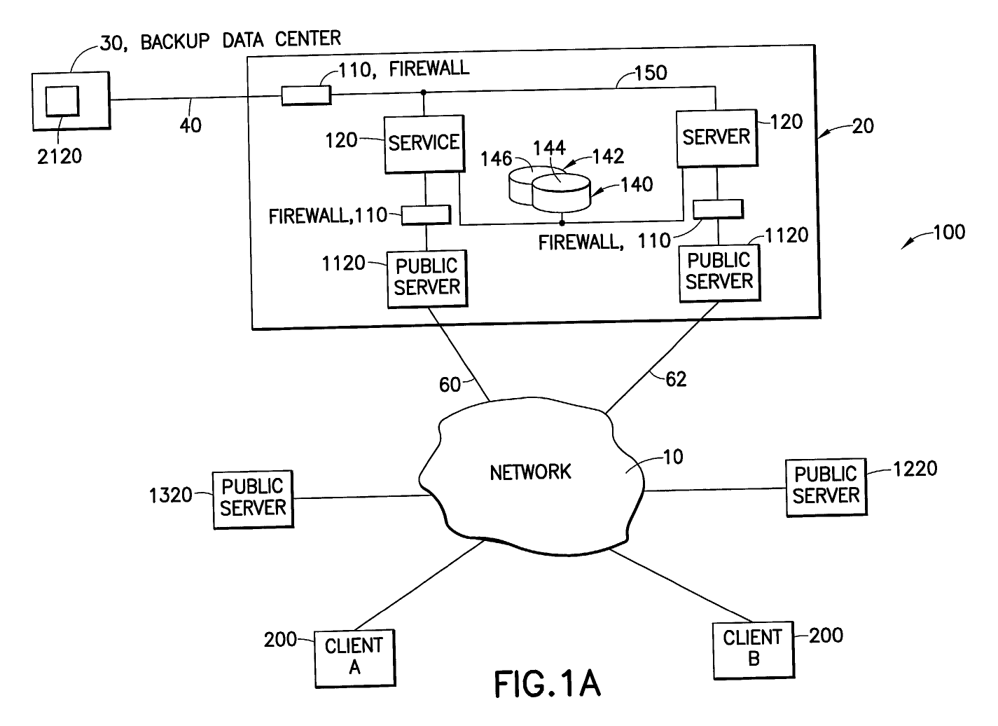

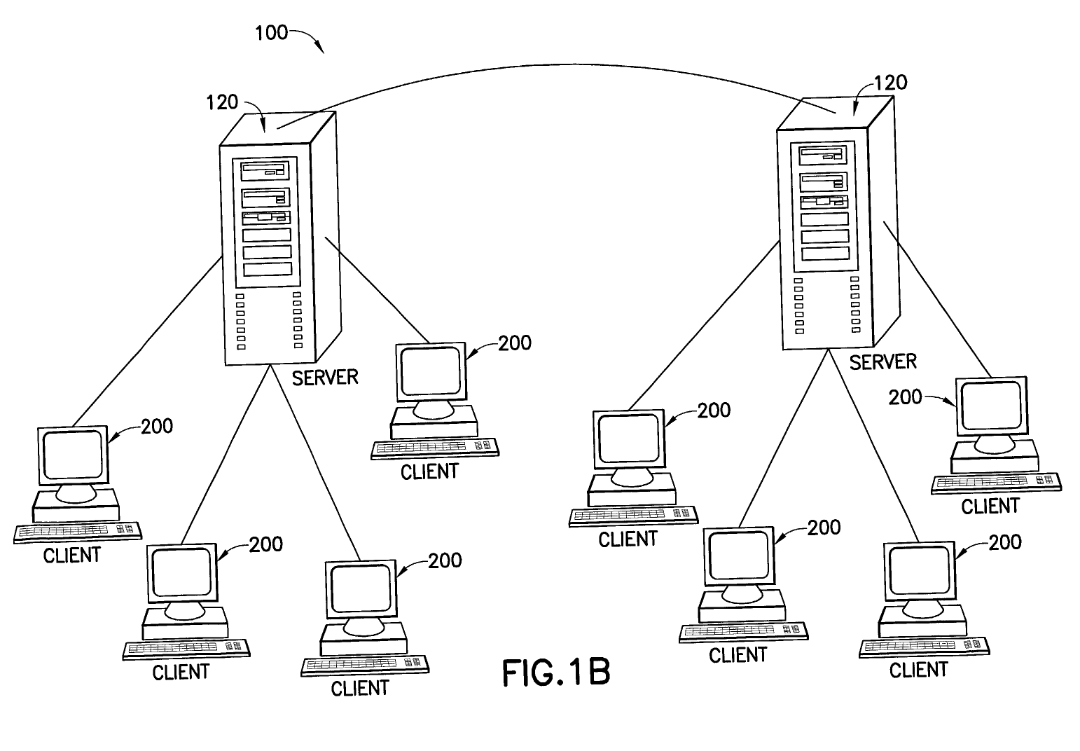

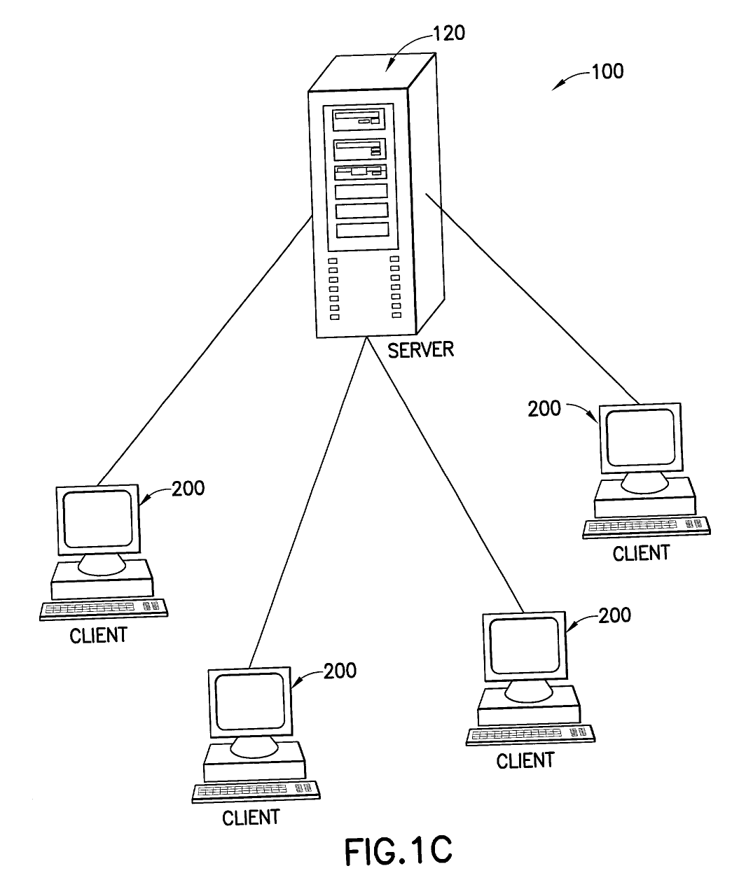

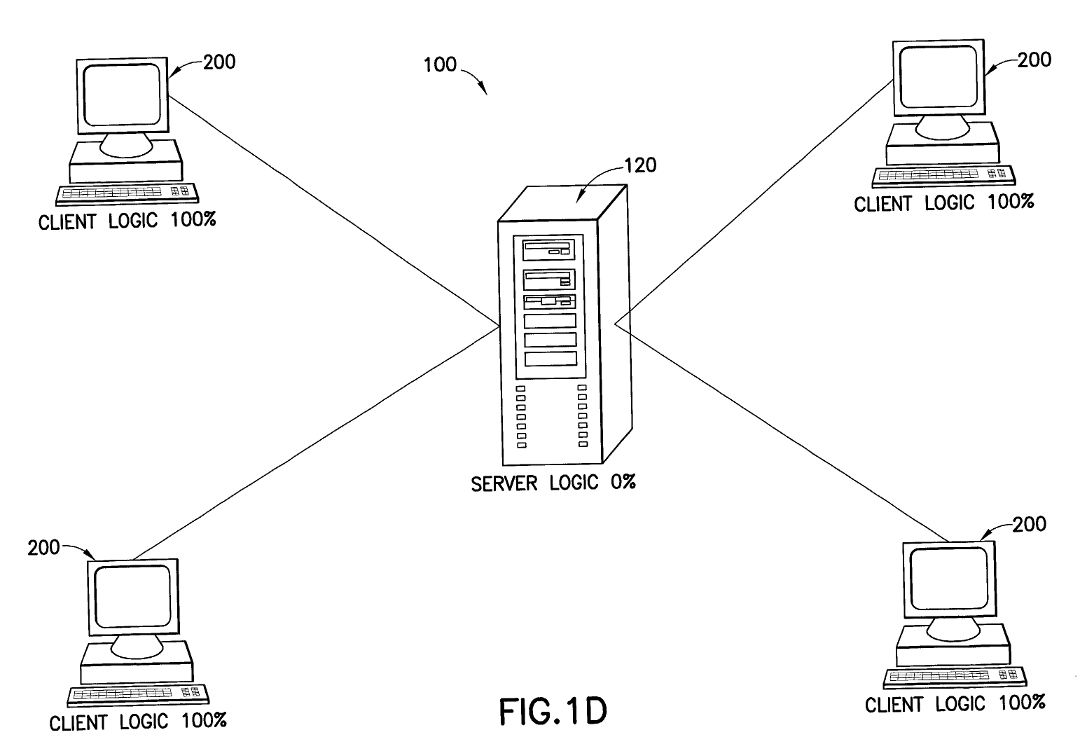

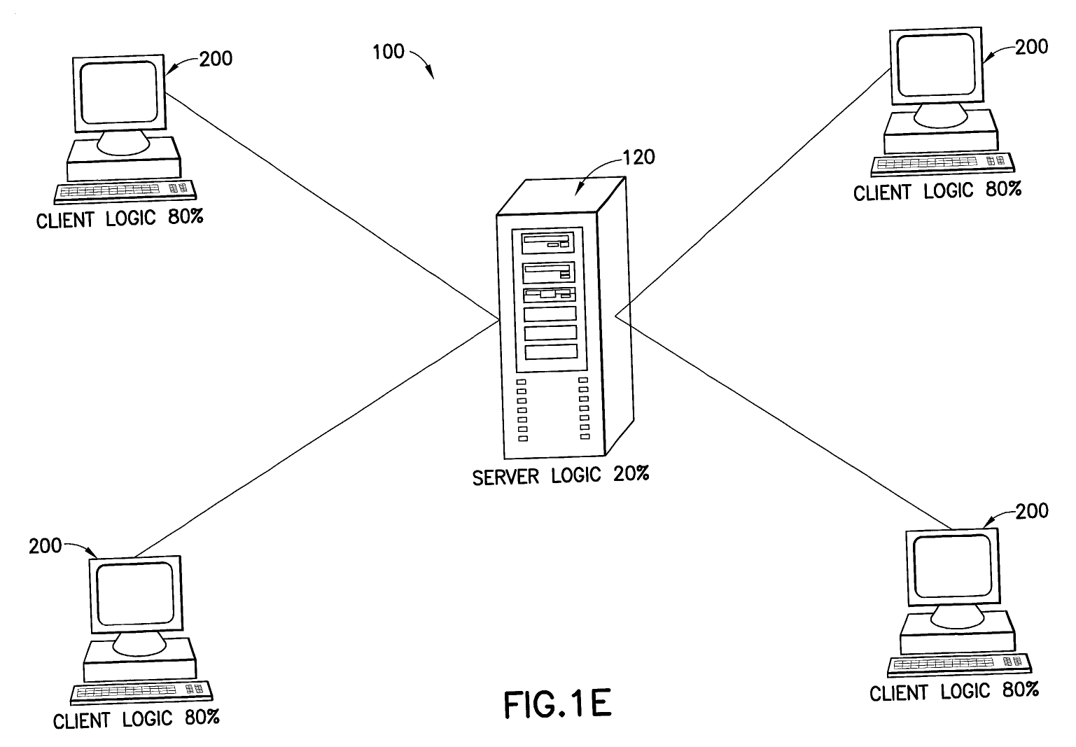

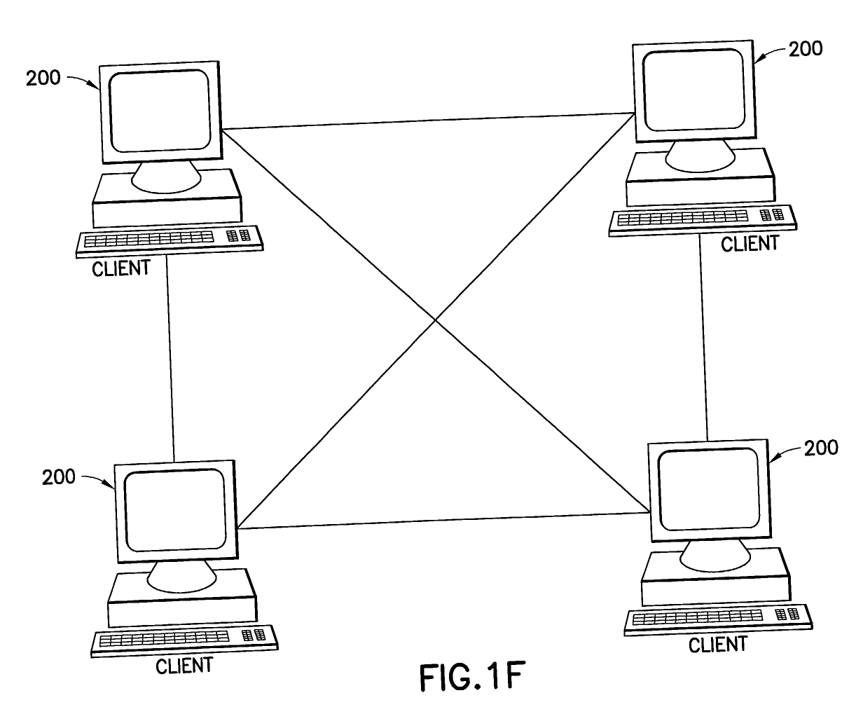

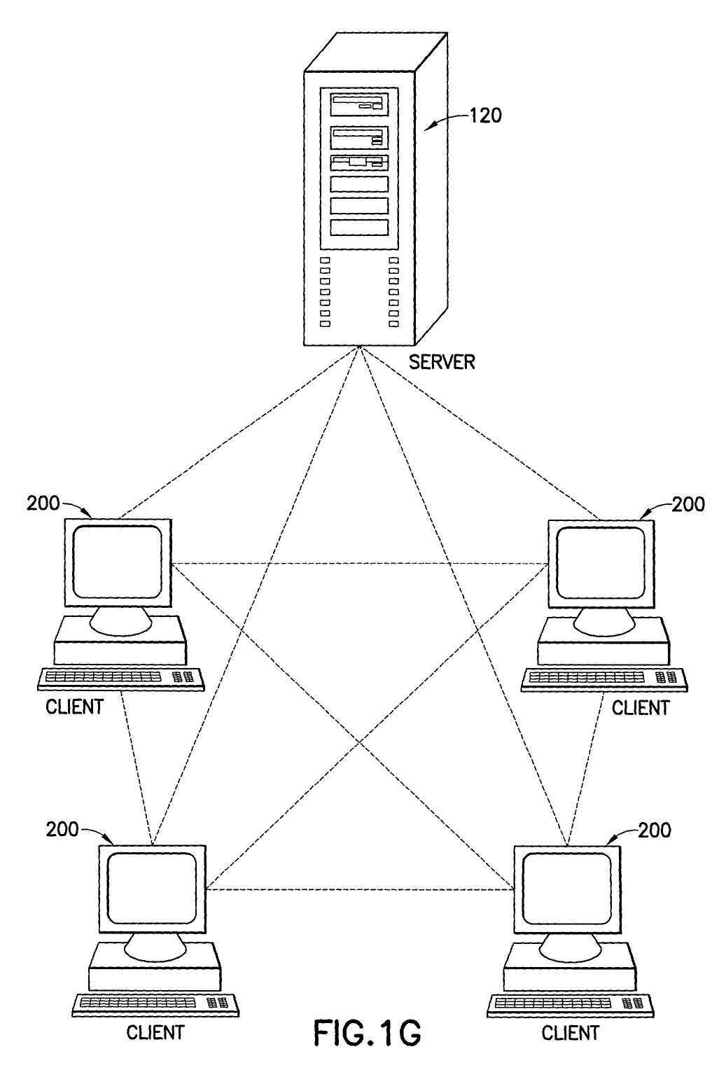

Referring next to the drawings and specifically to FIGS. 1A-1G, a system for multi-player computer game play in accordance with embodiments of the present invention is there depicted and designated generally by reference numeral 100. The inventive system 100 may utilize a client/server architecture that requires client computers 200 to connect through a server 120 with other client computers 200 and prevents direct client-to-client (i.e., player-to-player) connection (see, e.g., FIGS. 1A-1E). Such a configuration reduces the bandwidth requirements of each player, facilitates intervention by the server in decision making between players, and provides increased security by “overseeing” all aspects of game play and by restricting client access to certain data provided on the server 120. A preferred embodiment of the client/server architecture of the present invention provides a central data center 20 having at least one server 120 provided therein.

Alternatively, the system 100 may utilize a peer-to-peer architecture (i.e., client-to-client) in which all players (i.e., clients) may communicate directly with each other, such as depicted in FIG. 1F. In such an architecture, there is no central data center 20 or server 120, and client computers 200 may connect and communicate directly with each other. Multi-player game functionality is provided by each client computer 200, as described in more detail below.

Still alternatively, the system 100 may utilize a hybrid between the client/server and peer-to-peer architectures, as depicted in FIG. 1G. Communication between and among client computers 200 may be any combination of the peer-to-peer model, where clients communicate directly with each other, and the client/server model, where clients communicate with each other only through a server. A server referee 120 may monitor game-play for cheating and take appropriate action (e.g., drop a cheater's connection to the server 120 ).

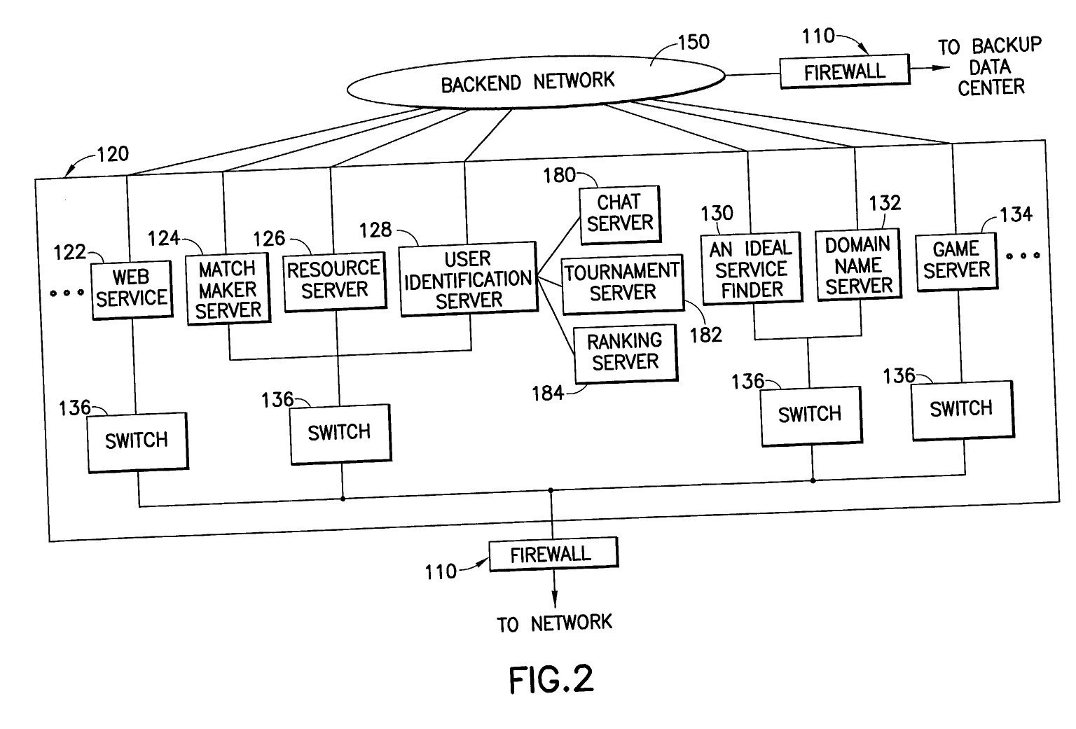

With continued reference to FIG. 1A, and with additional reference to FIG. 2, an embodiment of the inventive system 100 includes a primary data center 20 having at least two substantially identical server computers 120, each comprised of a plurality of computers, including, by way of non-limiting example, a web server 122, a match maker server 124, a resource server 126, a user (client) identification server 128, a chat server 180, a tournament server 182, a ranking server 184, an ideal service finder 130, a domain name server 132, and a game server 134. Alternatively, the functionality provided by those servers (as described in more detail below) may be provided on a single server 120 (or a primary and backup server 120 ), or grouped as appropriate so as to provide fewer servers. The server computers 120 are protected against unauthorized access, exposure to unauthorized data, etc., by a firewall 110 located between each server 120 and the network 10 and software such as security algorithms on servers and in operating systems, and may thus also be referred to herein as “protected” servers. Protected servers 120 are not directly accessible or connectable to a public network such as the Internet, for example. Those servers 120 typically have sensitive information (e.g., client identification and account data) stored in a database 144, 146 of a data storage device 140, 142.

The primary data center 20 may also include public server computers 1120 as part of the inventive multi-player game system 100. Those server computers 1120 connected directly to the network 10 and are accessible by a client computer 200. The public server computers 1120 may have additional security, as a matter of design choice, provided by appliances, firewalls, operating system, server applications, routers, or other known or hereafter developed applications or devices. For example, a web server 122 and resource server 126 may comprise public server computers 1120.

The protected servers 120 are connected to a backend network 150 that is self-contained within the primary data center 20 (e.g., a local area network (LAN)). The backend network 150 may comprise virtually any wired (e.g., twisted-pair, coaxial, fiber, etc.) or wireless (e.g., infrared, radio-frequency, etc.) network local to and contained within the building(s) that comprise the primary data center 20 (it being obvious to persons skilled in the art and from the disclosure provided herein that the primary data center 20 may comprise one or more buildings). Data storage devices 140, 142 are connected to the protected servers 120, each having a database 144, 146 provided thereon. In a preferred embodiment, data storage device 142 and the database 146 provided thereon provide mirror images of data storage device 140 and database 144, respectively. A further description of the data storage devices 140, 142 and databases 144, 146 are provided below. One or more backup server computers 2120 ) may be provided at a backup data center 30 which is connected via a private virtual connection (PVC) 40 and a firewall 110 to the backend network 150 of the primary data center 20.

Connection between the primary data center 20 and the network 10 may be via a primary connection 60 and a secondary connection 62 provided by an Internet Service Provider (ISP). Both the primary and secondary connections 60, 62 may be wired or wireless, as a routine matter of design choice.

With continued reference to FIG. 1A, additional server computers may be connected to the network 10 and may provide certain functionality of multi-player game play in accordance with the present invention. For example, a public server 1320 may be located remote from the primary data center 20, but geographically closer to a client (e.g., client A). During game play, it may be more efficient to provide certain functionality to client A from the public server 1320 than from the primary data center 20. The present invention enables and facilitates that situation. In addition, a rogue server 1220 may be connected to the network 10 and may similarly provide certain functionality to the client computers 200 during game play.

Each client computer 200 in the inventive system 100 has installed thereon special purpose software operable in connection with a processor of that computer. The special purpose software facilitates multi-player game play between and among client computers 200 regardless of the hardware platform, operating system, and hardware and communication protocol of each client computer 200. Depending upon the network configuration (se, e.g., FIGS. 1A-1G), communication between a client computer 200 and a server 120, or directly between client computers 200, will be facilitated by the special purpose software on the client computer 200. Special purpose software installed on the server 120 and operable in connection with a processor thereof also facilitates and coordinates multi-player game play between and among client computers 200. The functionality provided by each of the server 120 and client computers 200 depends upon the network configuration. For example, and as depicted in FIG. 1D, the server 120 may merely pass-through all client data, with all of the functionality being provided on each client computer 200. Alternatively, and as depicted in FIG. 1E, the functionality may be apportioned between and among the server and client computers (20/80 in that embodiment). Moreover, all of the functionality is provided on each client computer 200 for the configuration of FIG. 1F.

With reference next to FIG. 2, the protected server computer 120 of the primary data center 20 will now be discussed in more detail. As described above, the server 120 may comprise one or more computers including, by way of non-limiting example, a web server 122, a match maker server 124, a resource server 126, a user (client) identification server 128, a chat server 180, a tournament server 182, a ranking server 184, an ideal service finder 130, a domain name server 132, and a game server 134. Some of those servers may alternatively be provided as unprotected servers (see, e.g., 1120 in FIG. 1A), depending upon the functionality of the particular server and the sensitivity of an data stored on the server, for example. Which servers are provided as protected and which are provided as unprotected is a routine matter of design choice. Each server depicted in FIG. 2 may connect to the network 10 via a separate switch 136 or a plurality of servers may share a single switch 136. The connections depicted in FIG. 2 are exemplary of one of the many different connection schemes available between the servers and the network 10, and should not be interpreted in any way as limiting the scope or content of the present invention.

The functionality provided by the various servers depicted in FIG. 2, individually and/or collectively, facilitate and manage multi-player game play by a plurality of client computers 200 in accordance with the present invention. As described in further detail below, any of the servers (and its respective functionality) may be used at a particular time by the system 100 and accessed by a client computer 200, depending upon a particular game activity. For example, the matchmaker server 124 and its functionality may be utilized when a player (i.e., client computer 200) first attempts to connect to the server 120 and participate in multi-player game play. However, once that player has established a connection to a game server 134, the matchmaker server 124 and its functionality may no longer be required. Similarly, the other servers of the server cluster 120 may be utilized by the client computer(s) 200 at various times and in various different ways during the course of multi-player game play.

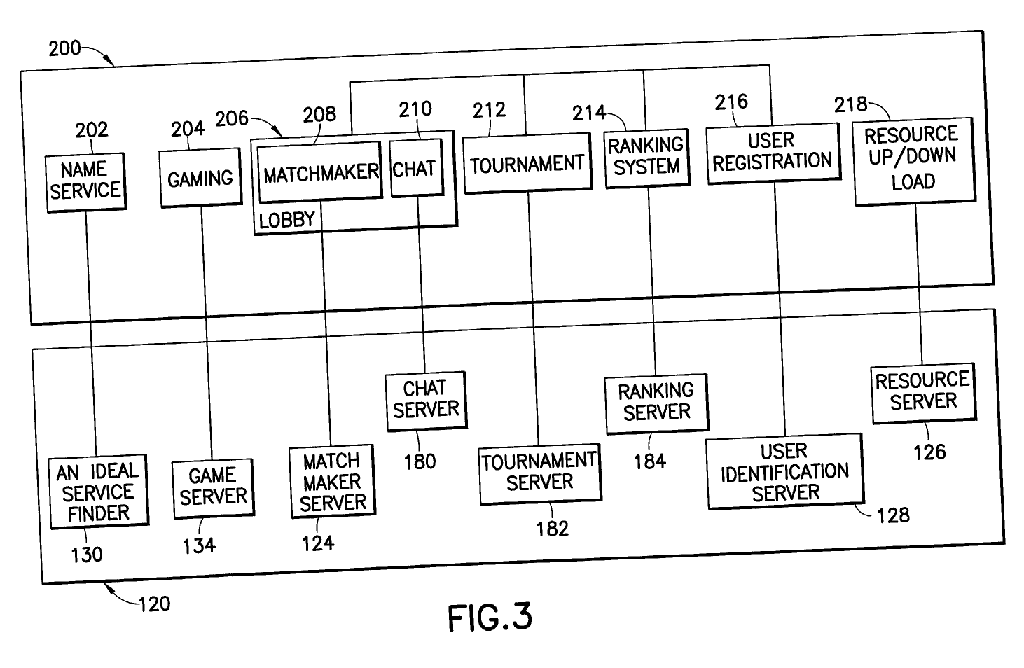

The multi-player functionality provided in accordance with embodiments of the present invention by the various servers 120 and by each client computer 200 are generally provided by special purpose software installed on the respective computer and operable in connection with a processor and, in some cases, with general purpose software also installed on the respective computer and operable in connection with the respective processor. The same or similar functionality may be provided on both the server 120 and client computer 200, depending upon the multi-player functionality requirements of a particular multi-player game and upon the configuration of the system 100 (e.g., client/server, client/client, etc.). At a minimum, the functionality provided on the client computer 200 will be a subset of the functionality provided on the server 120. This relationship is depicted diagrammatically in FIG. 3, in which the client computer functionality and server functionality, and the interrelationship therebetween, is depicted. While FIG. 3 depicts a single client computer 200 in relation to a single server 120, it should be noted that multiple client computers 200, having the same or similar functionality, may also “map” the functionality of the server 120, as depicted in FIG. 3.

With continued reference to FIG. 3, the functionality provided on a client computer 200 by the special purpose software in accordance with an embodiment of the present invention will now be discussed in detail. It will be obvious to persons skilled in the art that the special purpose software may be provided on any now known or hereafter developed storage medium (e.g., CD-ROM, DVD, etc.), downloaded to the client computer 200 (included on ROM or on cartridge), either in whole or in part, or otherwise loaded into memory of the client computer 200, as a routine matter of design choice. The functionality is provided by a plurality of components including name service 202, gaming 204, lobby 206 (including matchmaker 208 and chat 210 components), tournament 212, ranking system 214, user registration 216, and resource up/download 218 components. Each component provides functionality to facilitate communication between the client computer 200 and various functionality provided by the server 120.

In the embodiment depicted in FIG. 3, each of the functionality provided by the special purpose software in the client computer 200 has a corresponding and complementary functionality in the server 120. The connections between the client computer 200 and server 120 depicted in FIG. 3 are functional, and may not all concurrently exist, depending upon the functionality required at a particular point during game play. For example, the ideal service finder 130 and name service component 202 provide functionality to identify and locate, via symbolic names provided in a database on the ideal service finder 130, various resources and other functionality not provided via the special purpose software on the client computer 200. For example, a game server 134 may be provided as part of the primary data center 20 and also as part of a public server 1320. During game play, the client computer 200 may require information from a game server 134 that can be provided to that player from a game server 134 located on a public server 1320 that is geographically closer to the player than the game server 134 in the primary data center 20. The ideal service finder functionality facilitates the location of that closer game server 134. The use of symbolic names by the ideal service finder functionality eliminates the need to hard-code a network location for game servers and thus permits movement of the network location of the desired resource or functionality. More than one ideal service finder 130 may be provided in the system 100 (i.e., an ideal service finder 130 may be provided in both the primary data centers 20 and public server 1320 ). If more than one ideal service finder 130 is provided, the database of symbolic names is replicated to all ideal service finders 130 in the system 100.

With continued reference to FIG. 3, the game server 134 and gaming component 204 provide gaming functionality, which includes providing an in-game library and may facilitate game data communication between and among players during game-play. The game server 134 provides functionality to facilitate communication between and among client computers 200 through the server 120. The game server 134 may have stored thereon game state and synchronization information, and game management responsibilities (as between the various client computers 200 and various servers that comprise the server 120 ). The corresponding gaming component 204 facilitates connection between the client computer 200 and a game server 134 (client/server architecture), or between client computers 200 (peer-to-peer architecture).

The matchmaker server 124 and the matchmaker 208 component provide matchmaking functionality to enable a player to locate game servers 134 in the network 10 that satisfy player-defined requirements (e.g., game name, number of players, rules, ping time). The matchmaker server 124 preferably has a database of game servers 134 located in the network 10 with specifications (e.g., game type, number of simultaneous players, etc.) for each game server 134 included in the database. More than one matchmaker server 124 may be provided in the system 100.

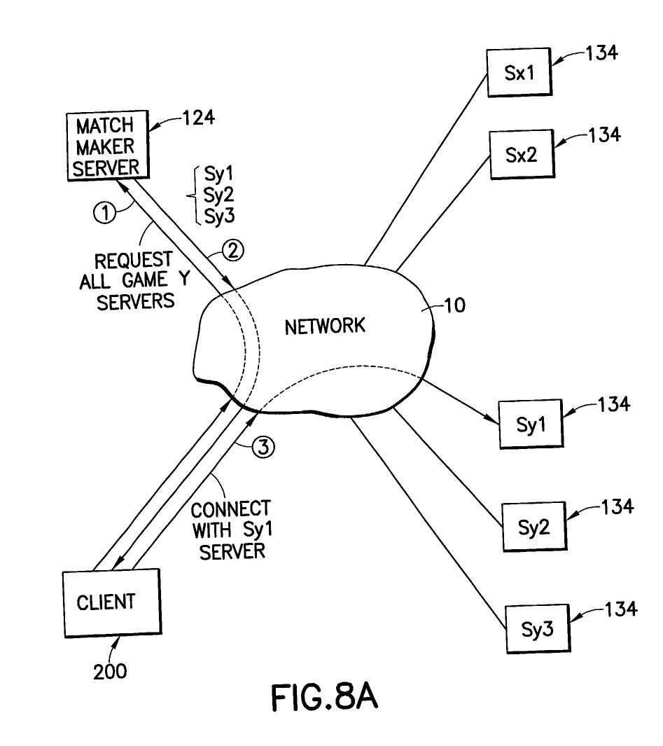

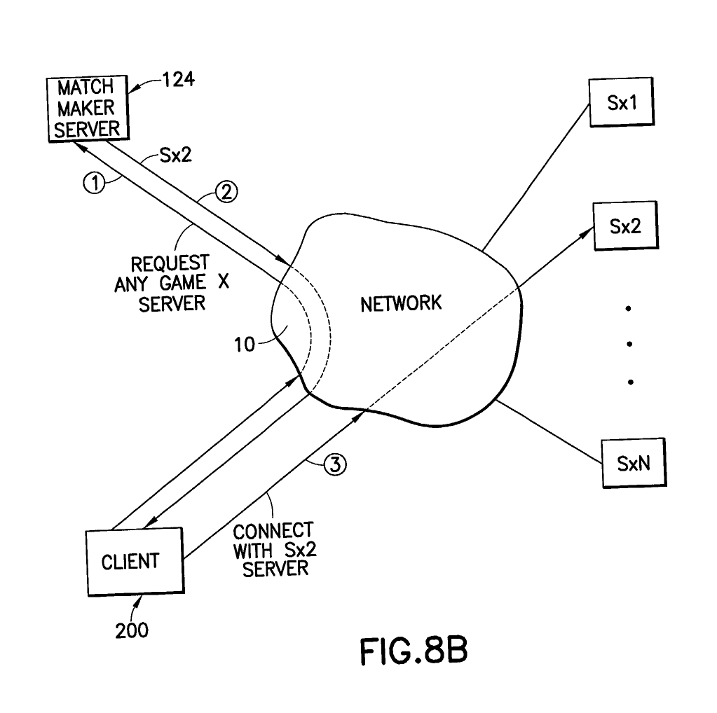

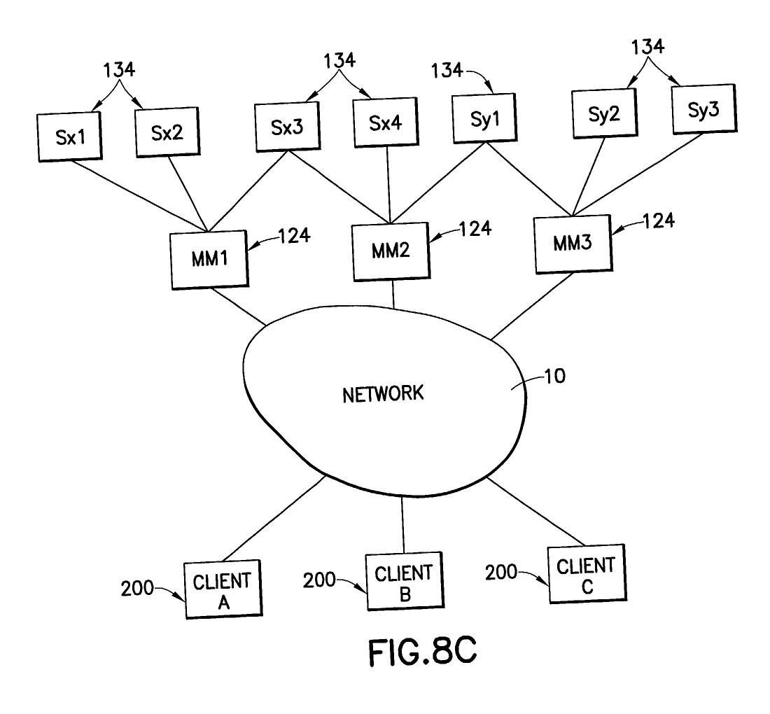

Referring next to FIGS. 8A-8 C, the functionality of the matchmaker server 124 will now be discussed in greater detail. A matchmaker server 124 may have stored in a database thereon a list of game servers 134 for one or more multi-player games, e.g., game X, game Y, etc. When a client computer 200 requests a game server for game X via the matchmaker component 208, matchmaker server 124 can return to the client computer 200 available game X game servers 134. With that information returned to the client computer 200 from the matchmaker server 124, the client computer 200 can connect to and participate in multi-player game play on any of the game X game servers 134. Similarly, the matchmaker server 124 can direct a client computer 200 to a game Y game server 134. For example, if client computer 200 desires to participate in game Y, a request may be communicated by the matchmaker component 208 resident on the client computer 200 to the matchmaker server 124 (designated as 1 in the figure). Matchmaker server 124 determines the game Y servers 134 available to the client computer, and communicates a list of those servers to the client computer 200 (designated as 2 in the figure). Selection of the game Y server 134 to which the client computer 200 ultimately connects is then left up to the user of the client computer 200. In FIG. 8A, client computer has elected to connect with game server Syl (designated as in the figure).

Alternatively, and as depicted in FIG. 8B, the matchmaker server 124 can return to the client computer 200 a particular game X game server 134, to which the client computer 200 can then connect and engage in multi-player game play of game X. In FIG. 8B, the client computer has communicated a request to the game server 124 (via the matchmaker component 208 ) for a list of any game X server 134 (designated as 1 in the figure). Game server 124 returns information on game server Sx2 to the client computer 200 (designated as 2 in the figure). The client computer 200 then establishes a connection to game server Sx2 (designated as 3 in the figure).

In another embodiment, depicted in FIG. 8C, a plurality of matchmaker servers 124 may have respectively stored thereon lists of game servers 134 for one or more multi-player games, e.g., game X, game Y, game Z, etc. That configuration provides enhanced reliability and load balancing between and among the plurality of matchmaker servers 124. If one matchmaker server 124 is experiencing problems or is overwhelmed with requests from a plurality of client computers 200, another matchmaker server 124 can provide matchmaker functionality. A request from client computer A for a game X server may be handled by matchmaker server 1 (MM1) or 2 (MM2), both servers having information on game X servers. Similarly, matchmaker server 2 (MM2) and 3 (M3) can handle request for game Y servers.

In each of the above-described embodiments of the matchmaker server 124 (depicted in FIGS. 8A-8C), the request from the client computer 200 to locate a game server 134 may include certain performance characteristics desired of the game server 134 and client computer 200 and the connection therebetween. For example, a client may submit, in its request to the matchmaker server 124, criteria such as game name, number of players, rules, world in which the game is being played, and ping-time (e.g., best performance, least latency, random selection, etc.).

The chat server 180 and the chat component 210 provide chat functionality to enable players to communicate (typically via textual messages) over the network 10, i.e., to send and receive instant messages, chat-room messages, group messages, and the like. The chat server can receive a textual message from the chat component 210 of a first client computer 200 (e.g., client A). Included in the message will be the identification of the desired recipient(s) (e.g., client B, client C, etc.). The chat server 180 receives that message, interprets the recipient(s), and transmits the message for receipt by the chat component 210 of the client computer(s) 200 of the desired recipient(s).

The tournament server 182 and the tournament component 212 provide tournament functionality that facilitates tournament game-play between and among a plurality of client computers 200. The tournament server 182 provides a forum for registered clients to demonstrate their game skills by participating in game tournaments which server to eliminate and rank players according to their skill as demonstrated by their success over other players.

The ranking server 184 and the ranking system component 214 provide ranking functionality to track individual and/or group player statistics, compare players, rank players, etc.

The user (client) identification server 128 and the user registration component 216 provide user identification and registration functionality the permits players to register, assigns a unique player identifier for each player, defines player profiles for each player, and authorizes or denies player access to game services via the system 100. The user (client) identification server 128 communicates directly with the data storage device 140 and database 144 provided in the primary data center 20. New clients must first register, with that registration data being stored by the user identification server 128.

The resource server 126 and the resource up/download component 218 provide resource functionality that enables a client to upload and download game resources from other servers to the client computer 200 during game-play. For example, a client may download new game graphics, updated sports statistics, post-production advertisements, and client-customized data (e.g., racetrack, player representations, etc.). A client may also upload client-customized data (e.g., from the client computer to the resource server 126 ). The resource server 126 may be provided in the primary data center 20 and may function as a master resource server and preferably includes complete data on the location in the network 10 of all available resources (e.g., all other public servers 1320, rogue servers 1220, and other unprotected servers 1120 ).

The server 120 (or one or more of the above-mentioned servers that may comprise the server 120 ), may also provide a buddy list manager that is operable in connection with the user (client) identification server 128. For example, a client computer 200 may initiate a particular multi-player game with appropriate restriction instructions that only buddies of that client (as provided by the buddy list manager) can participate in that game.

An ideal service finder may also be provided by the server 120 (or by one or more of the above-mentioned servers) that enables a client to locate a service that best suits that client's particular requirements. For example, a client may locate optimal services on the Internet (i.e., the network 10 ) without experiencing any IP-related address problems. The ideal service finder maintains data (e.g., performance, local feedback, etc.) on registered services (i.e., those services of which the ideal service finder is aware) and utilizes that data in selecting an ideal service for a particular client requirement.

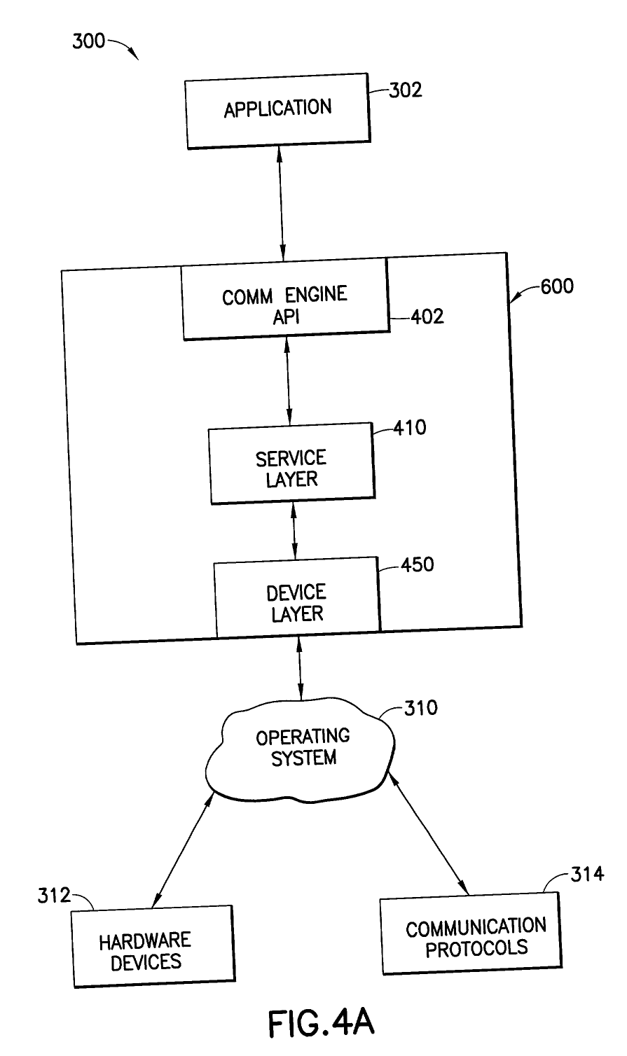

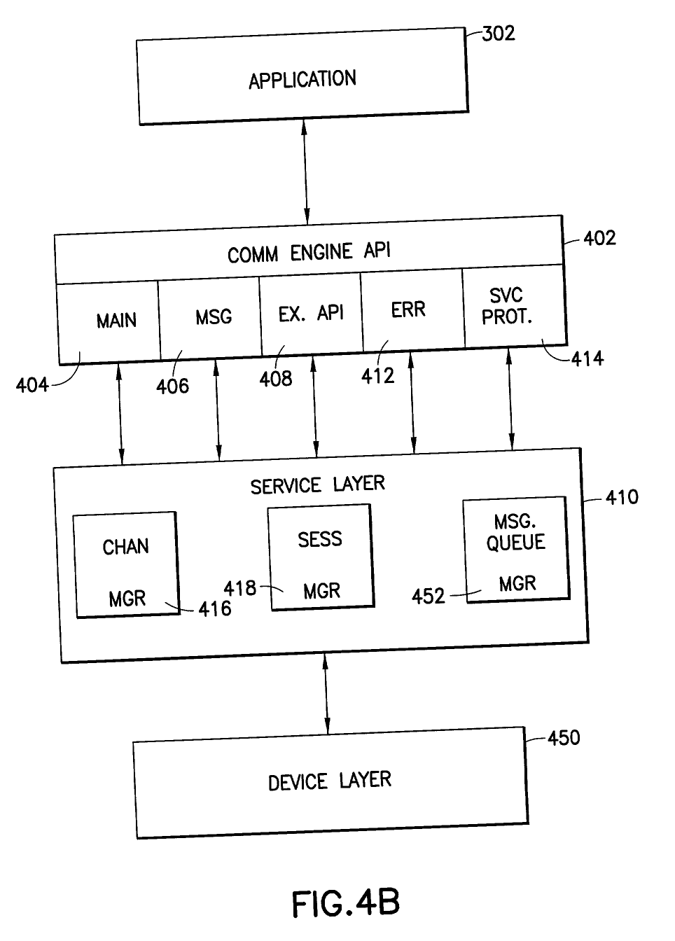

With reference next to FIGS. 4A and 4 B, special purpose software operable in connection with a processor of a client computer 200 in accordance with an embodiment of the present invention utilizes a cross-platform core (CPC) 320 which is a collection of modules that allows programmers to develop similar programs (i.e., games) operable on and in connection with multiple hardware and operating system platforms with minimal development overhead. For example, the CPC 320 provides cross-platform compatibility with Windows 95, 98, NT, Win 2000, Windows CE, Linux, Unix, Solaris operating systems, and with various hardware platforms and gaming consoles. The CPC 320 of the present invention enables multi-player computer games (or virtually any other software) installed and operating on a first hardware platform in connection with a first operating system to seamlessly communicate with multi-player computer games (in most cases, the same multi-player computer game) installed and operating on a second hardware platform in connection with a second operating system. The CPC 320 provides for cross-platform communication that enables game algorithms and programs to operate on different hardware platforms regardless of differences in operating systems, system application programmer interfaces (APIs), memory, file system, threads, times, etc. Thus, player A running a multi-player game utilizing the present invention and installed on a personal computer and living in New Jersey may play against player B having the same multi-player game installed on a Sega Dreamcast® and living in California.

The special purpose software also includes a communications (comm) engine 402 to facilitate communication (i.e., bi-directional data transfer) between an application module or code 302 and the operating system 310, hardware devices 312, and communication protocols 314 of the client computer 200. The comm engine 600 (also referred to herein as a comm engine API) is a cross-platform library which provides standardized functionality for communication between certain hardware devices such as, for example, choosing, initializing, connecting, and sending/receiving data to/from a device. The comm engine 600 comprises a service layer 410 and a device layer 450. The CPC 320 and comm engine 600 provide a communication foundation for software application development and that provides hardware, software, and protocol independence, and that provides for customizable software algorithm features. The CPC 320 eliminates the need for software programmers to consider communication details (i.e., protocols) when writing a multi-player computer game.

The CPC 320 identifies the computing device hardware platform and operating system, provides a cross-platform ANSI C library, a cross-platform hardware emulation layer (HEL), and provides release and debug options. The CPC ANSI C library includes main system files such as, for example, hardware platform target and storage type files, ANSI C compatibility layer files, and advanced hardware abstraction layer (HAL) files. Those files in turn will include the various sub-components of the CPC 320, as discussed in more detail below. The various sub-components can be called individually, or through their grouping file or through the complete file listing.

The platform target and storage type files contain all the definitions and constants which are required to determine platform specific functionality as well as cross-platform type standards.

The ANSI C compatibility layer file contains ANSI C compatible functionality definitions. The ANSI compatibility layer file provides function that are found in the ANSI C library. That includes standard features such as, by way of non-limiting example, memory, string and math. The ANSI C compatibility layer file provides those features without any operating system deviations. For example, although ANSI C has defined standard ways to carry out time functions, certain operating systems use modified versions of that standard. Thus, it is difficult to develop time functions that are portable across multiple operating systems. The ANSI C compatibility layer file obviates that problem by providing ANSI-equivalent interfaces to access time functions in any operating system. In addition, certain operating systems may not provide a full ANSI C library. In that case, the ANSI C compatibility layer file of the present invention provides the missing functionality.

The advanced HAL files include functionality that are not included as part of the ANSI C standard. That includes functions that define what operating system is running, threads, debugging and other important functions that are fairly standard but not available or not consistent on all platforms. For example, C++ new and delete functions may be defined in these files.

Referring next to FIGS. 4A and 4B, the components and architecture of the special purpose software of the present invention will now be discussed in detail. A multi-player game constructed in accordance with the present invention will have the architecture generally depicted in FIG. 4A and generally designated by reference numeral 300. The game 300 includes an application component or module 302 which comprises the application software specific to the game type (e.g., sports, fast twitch, turn-based, etc.). The application module 302 interfaces directly with the core technology which comprises a communications (comm) engine 600 that sits on top of a cross-platform core (CPC) 320. The CPC 320 comprises a plurality of files (i.e., a collection of modules) that enables programmers to develop similar programs (e.g., multi-player computer games) that will run on multiple hardware and operating system platforms with minimal software development overhead. The CPC 320 provided cross-platform compatibility with Windows 95, 98, NT, Win 2000, Windows CE, Linux, Unix, Solaris and various gaming consoles. Thus, multi-player computer games may be quickly and easily developed to operate in connection with any hardware and software platform and configuration, and to communicate with any other hardware and software platform and configuration.

The comm engine 600 provides the interface between the application module 302 and the operating system 310 and various hardware devices 312 and communication protocols 314 specific to each computing device hardware platform. When writing the application module 302, the software developer need not code to a specific operating system, nor consider the hardware or protocol requirements of a particular hardware platform. Instead, the application module 302 is written (i.e., coded) to interface to the comm engine 600, may be run on any operating system, and may utilize any hardware device and communication protocol supported by the comm engine 600. The comm engine 600 is a general-purpose cross-platform communications engine that makes programming network applications quicker, simpler, more efficient and more robust. It provides a technological foundation for multi-player games and web-based applications. The comm engine 600 satisfies cross-platform necessities, and may support operating systems such as, by way of non-limiting example, Microsoft Windows 95, 98, 2000, NT, and CE, Linux, Solaris, SGI, personal digital assistant (PDA) operating systems, and wireless operating systems. It will be obvious to persons skilled in the art, and from the disclosure provided herein, that other now known or hereafter developed operating systems may also be supported by the comm engine 600.

The comm engine 600 includes a comm engine API 402, which includes a main module 404, message (msg) module 406, external api (ex_api) module 408, error (err) module 412, and service protocol (svc prot) module 414. The message module 406 provides the application 302 a generic way to send data through the comm engine infrastructure without the client having to wary about memory allocation and speed issues. The error module 412 is used by comm engine 600 as a way to let the client know that an error has occurred in the comm engine 600. Along with the broad errors, helper functions are provide in other to extend the functionality of the error module 412. These helpers provide a textual representation of the errors. The service protocol module 414 extends the functionality of comm engine 600 by providing commonly used services like compression and encryption to the client.

The comm engine 600 interfaces with a service layer 410 which includes a channel manager (chan mgr) 416, a session manager (sess mgr) 418, and a message queue manager (msg queue mgr) 452. The channel manager 416 manages channel lists for the sessions. The session manager 418 drives the channel manager 416 by causing it perform operations on its channel lists. Any tasks that need to be performed through the device layer channels will be processed via the channel manager 416. An example would be sending a message through the device layer 450. Each channel contains send and receive queues, a device protocol, device information, addressing information, a software protocol stack, and configuration information.

The service layer 410 shields application modules 302 of specific operating systems (OS), hardware device, and communication protocol requirements. Programmers need only code to the service layer 410 (via the comm engine 600 ), which performs all conversions required for the application module 302 to interface to the operating system and various devices and protocols. The service layer 410 also provides access by the application module 302 to advanced engine protocols and permits software developers to easily insert custom application protocols.

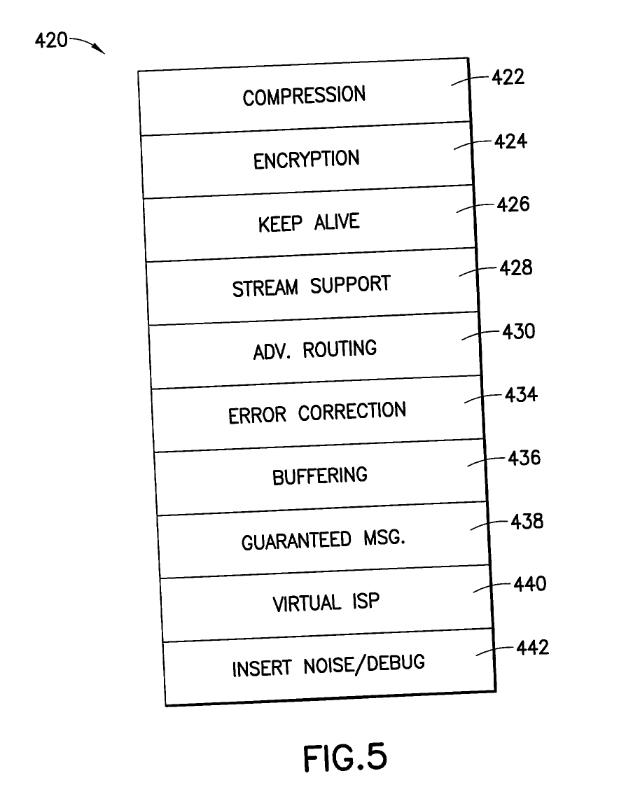

The service layer 410 may be generally considered a hardware-emulating layer (HEL) because it forwards hardware implemented calls to the device layer 450 and may supply hardware features/emulation. The service layer 410 may also supply optional internal protocols that can be used by the application module 302, if needed. The service layer 410 may also permit an application module 302 to supply its own protocols, which can be inserted at different points within the service layer protocol stack 420, an illustrative example of which is depicted in FIG. 5. That protocol stack 420 includes high protocol functionality such as compression 422, encryption 424, keep alive 426, and stream support 428, and low protocol functionality including advanced routing techniques, 430, error correction 434, buffering 436, guaranteed messages 438, virtual ISP 440, and insert noise/debug 442.

Send priorities can be used by the protocol stack 420 to optimize bandwidth, optimize protocol buffer management and conserve CPU usage. In essence it allows outgoing packets to be combined if possible into a single outgoing packet. Every incoming and outgoing packet must be packed, processed, cause a CPU context switch, do hardware send, etc. If no optimization is done, high packet counts can cause significant local overload and latency. Depending on the particular communication medium employed by an application module 302, send priorities may be optimized. When accessing the Internet using a relatively slow connection (e.g., 28.8 K modem), latency may be greater than 200 milliseconds (ms). With that knowledge, normal priority packets may be grouped within a predetermined time window. As an example, any pending normal packets not timed to be sent yet, may be flushed and sent if a high priority packet is about to be sent. The expiration time window for each send priority can be configured so that send priorities can map to send within the next predetermined time window.

The buffering 436 protocol of the service layer protocol stack 420 may consider any unnecessary memory allocations, freeing, copying, etc. In addition, internal receive buffers may be directly examined, used, and copied. An example of some of the optimal packet manipulation operations is the ability to add/remove header/footer from the data packet with high probability that no memory allocations/free/copying will be done. A dynamic protocol buffer pool is also provided, containing pre-allocated and previously configured protocol buffers for use as needed.

The virtual ISP protocol 440 provides all the necessary hooks to simulate an application's performance over the Internet. The virtual ISP protocol 440 enables an application module 302 to be tested using a LAN configured (from the application module's perspective) as an Internet ISP connection. The virtual ISP protocol 440 enables simulation, to the service layer 410, of the following situations: random failure to connect, random loss of connection, random latency injection with variance, and random loss of packets. The virtual ISP protocol 440 options are fully configurable to provide the many types of ISP connections over different mediums. For example, both tier I and tier 3 Internet connections may be simulated. Fast or slow connections and device behavior, such as disconnect packet drops, may also be simulated using the virtual ISP protocol 440.

Another benefit of the virtual ISP protocol 440 is security. Connection to the Internet is no longer required to see how communications software will behave.

The device layer 450 is the low-level, cross-platform, device independent layer of the comm engine 600. It handles the operating system specific API calls, platform specific issues of byte-ordering and data alignment, and device specific programming techniques to present a common API for all platforms. The device layer 450 provides a unified interface to different communication devices on all operating systems; for direct and immediate function performance; makes it easy to add new devices by adding a new device API; hides operating system specific details from the software engineer; hides details of device-specific types or structures from the software engineer; hides details of device-specific APIs from the software engineer; can be used as a direct API to devices (for example, the device layer will map a generic “SEND( )” command to a specific “DevApi_Send( )” command); and provides a common interface regardless of the intended operating system, platform, network protocol, etc., the application module 302 is intended to operate on or in connection with.

The device layer 450 hides implementation details about different networking protocols, operating systems and communications devices. In this way, programming a modem on the Linux OS using a dial-in mechanism is programmed from a higher level exactly the same as a Windows machine using a network interface card (NIC) and the TCP/IP protocol. From the application module's 302 perspective, the same sequence of subroutine calls are used and only the addressing parameters are different. Additionally, the different address types can be prepared using helper subroutines so that the actual implementation of the address is hidden from the user.

The device layer 450 provides a unified interface to all hardware devices and protocols for any operating system. The device layer 450 contains all the hardware platform specific code, including any code that deals with different hardware, protocol implementations and the various operating systems. Thus, support in the comm engine 600 for a new operating system, network device or protocol may be done by adding support for it in the device layer 450 alone.

The device layer 450 may be considered a hardware abstraction layer (HAL) and includes code to provide an interface between an application module 302 (via the service layer 410 ) and various devices (i.e., hardware platforms), operating systems, and networking protocols.

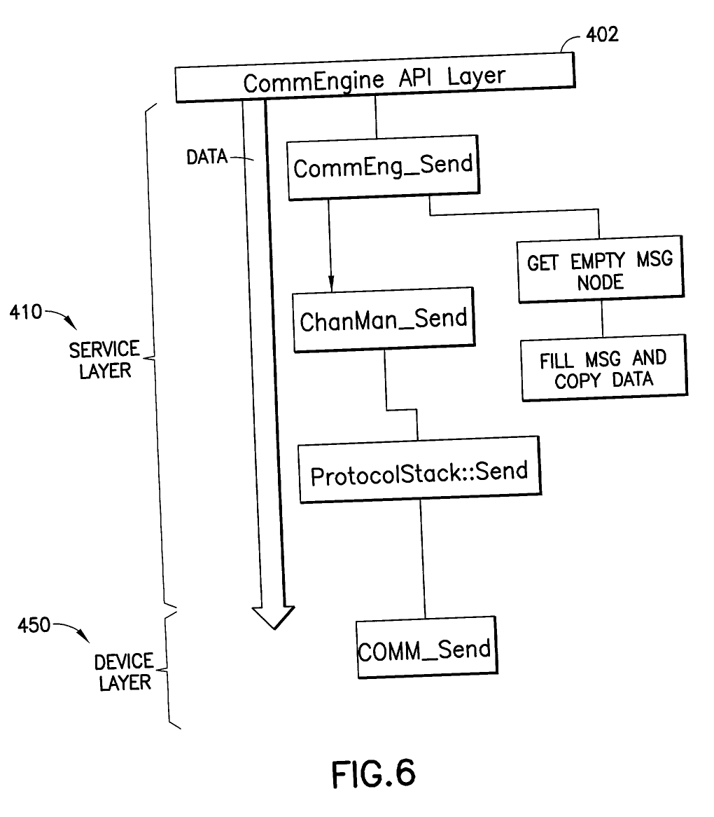

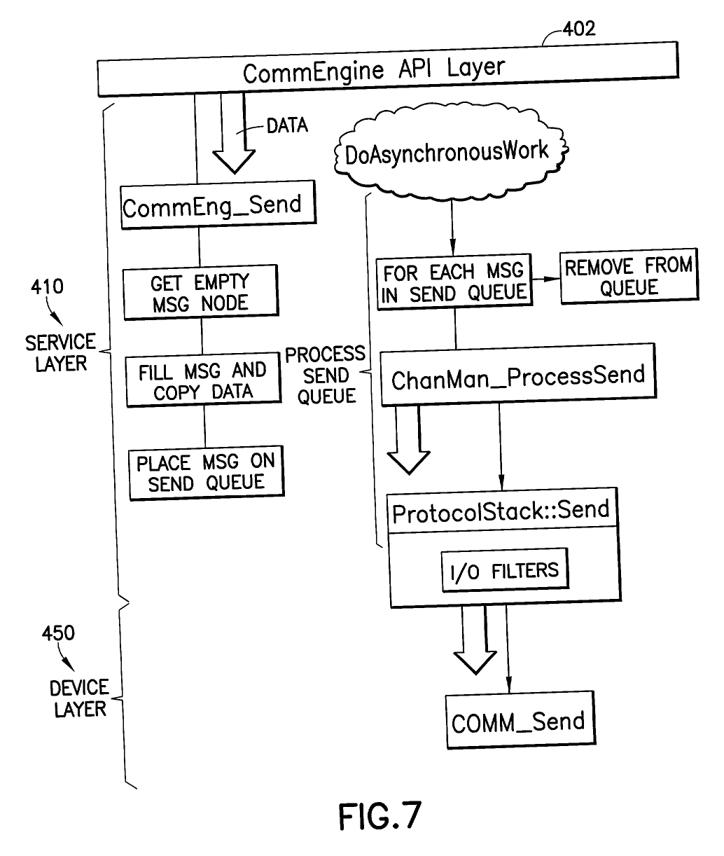

The comm engine 600 generally has three modes of usage: pass-through mode; synchronous mode; and asynchronous mode. Each mode utilizes the functionality of the comm engine 600 differently. These modes and how they require usage of the comm engine 600 functions are described in more detail below, and with reference to FIGS. 6 and 7.

In pass-through mode, depicted in FIG. 6, the comm engine 600 acts as an interface to the functionality of the device layer 450. An additional feature of pass-through mode is the ability to set data filters through which the data is passed before being communicated over the network 10 (with corresponding filters on reception). For example, data may be compressed and/or encrypted before being transmitted and then decrypted and decompressed when received.

For pass-through mode operation, the application module 302 creates a session and then creates and opens channels in that session. Connections are accepted if applicable, and data is sent back and forth directly between the device layer 450 and application module 302 via the comm engine 600 without buffering or queuing the data in any way. Essentially, pass-through mode expects that the application module 302 is familiar with network program and is simply using the comm engine 600 to hide device, protocol, and operating system details.

Data flow for synchronous and asynchronous mode operation of the comm engine 600 is depicted in FIG. 7. In asynchronous or synchronous mode, the comm engine 600 buffers data, provides data filtering services, and queues messages for the application module 302. Additionally, an event-driven methodology may be employed in which the library user (i.e., the application module 302 ) is notified about events such as a new connection, when new data has been received, channel disconnection, etc.

In synchronous mode, depicted in FIG. 7, the application module 302 controls when the comm engine 600 performs its work. It is different from the pass-through mode in that message queues and notification methods are available so an event-driven methodology may be used when programming the application module 302. However, the comm engine 600 must frequently and unequivocally be permitted to perform work by calling a subroutine that enables synchronous operation and functionality, such as CommEng_DoSynchronousWork (discussed in more detail below). The term “subroutine”, as used herein, includes subroutines, callbacks, functions, etc., and is used herein to refer to instances where additional functionality is provided to/for an application program by virtue of that application program (or an application program relating thereto) invoking, executing, causing to execute, etc., another application having that additional functionality. The subroutine may perform some functionality for the application program, receive data from and pass data to the application program (or to another application program, subroutine, library, etc.), invoke other subroutine(s), etc., as directed by the application program. The subroutine names provided herein are merely illustrative, non-limiting examples of names used to facilitate discussion of the present invention and are not intended to define or otherwise limit the scope of the present invention, it being obvious to persons skilled in the art and from the disclosure provided herein that any subroutine name may be used. The functionality of the various subroutines referred to herein as described in more detail below.

Synchronous mode is useful for taking advantage of priority message queues and the event-driven programming paradigm. In synchronous mode, no threads are used in the underlying networking code and the comm engine 600 only does its processing of data when the application module 302 calls a subroutine such as the CommEng_DoSynchronousWork. Additionally, the application module 302 may take advantage of several protocol services (such as encryption, compression, streaming, etc.) without having code specific to that functionality.

In asynchronous mode, depicted generally in FIG. 7, the comm engine 600 runs using threads and allows the programmer (i.e., the application module 302 ) to be notified when an event occurs asynchronously. For instance, when a new connection occurs, the application module 302 will be notified via an appropriate notification method. Whenever data is available on a channel of communication, the application module 302 is notified that the data is available in the same way, thus obviating the need for the application module 302 to poll for events and also prevents the application module 302 from having to allow the comm engine 600 to work periodically.

Asynchronous mode is similar to synchronous mode except that there is no need to cause the comm engine library to call the CommEng_DoSynchronousWork subroutine, or to create threads to handle performing network communications asynchronously.

When the application module 302 sends data, a CommEng_Send subroutine is called which results in a message getting placed onto an appropriate send queue. The send queue is eventually processed (either when the CommEng_DoSynchronousWork subroutine is called or when an internal thread does so) and each message is passed to a ChanMan_ProcessSend subroutine which in turn routes it to either the appropriate channel's protocol stack or directly down to the device layer 450.

The functionality provided by the comm engine 600 is provided, at least in part, by subroutines invoked by the comm engine 600. Those various subroutines enable the comm engine 600 to operate in pass-through mode, synchronous mode, or a asynchronous mode, as required by the application module 302. Those subroutines also shield the application module 302 from the specific hardware, operating system, and protocol requirements of specific computing device. Thus, the comm engine 600, service layer 410, and device layer 450, and the various comm engine subroutines, facilitate rapid and economic development of multi-player computer games and facilitate and manage communication between and among players in computing devices, regardless of differences in hardware, operating system, or protocol for those computing devices, to provide seamless conductivity among game players over a network.

The following description and names for the comm engine 600 subroutines are provides as illustrative, non-limiting examples to facilitate discussion of the present invention.

CommEng_Startup

This subroutine causes the application module 302 to initialize any necessary libraries. In the case where the implementation is a static library, this subroutine is called only once by the application module 302 to allocate and initialize global library resources. If the implementation is as a shared library (.so) or Dynamic Link Library (.DLL), then each executable (provided as part of or used by or in connection with the application module 302 ) which makes use of the comm engine 600 calls the CommEng_Startup subroutine before accessing any other subroutines. That ensures that the comm engine 600 library is initialized properly for performance and memory management reasons.

The comm engine 600 keeps a reference count of current users of the comm engine 600 so that it knows when it can unload itself from memory and perform other cleanup tasks.

CommEng_Shutdown

This subroutine is called when the comm engine 600 is no longer necessary to the executable file or software module 302 using it's API. By calling this subroutine, the library reference count is reduced and any unnecessary resources are de-allocated and given back to the system (i.e., made available for use by the computing device hardware and software) as appropriate. As used herein, the term “system” refers generally to the computing device and general and special purpose software.

CommEng_OpenSession

This subroutine is called by the application module 302 to create and initialize a session. A session can be open in three ways. For pass-through operation, an eCommSession_PassThrough subroutine may be invoked by which the service layer 410 does the minimum amount of work on the data and simply passes the data straight to the device layer 450. For synchronous operation, an eCommSession_Sync subroutine may be invoked, which is recommended for a platform that does not have threads. That subroutine allows the service layer 410 to function as if threads are available in the system. When an eCommSession_Sync session is opened, the application module 302 (or other application that established that session) is responsible for ticking the service layer 410 in a timely manner.

For asynchronous operation, an eCommSession_Async subroutine may be invoked, which provides the most efficient and fastest way to open a session. The application module 302 is notified of any data or errors that occur through the callback subroutine.

If synchronous or asynchronous mode with notifications is required, then the pNotifyMethodData parameter must point to a structure providing the notification details.

CommEng_CloseSession

This subroutine is called to destroy and cleanup an existing session.

CommEng_GetDeviceCount

This subroutine returns the number of communications devices on the system.

CommEng_GetCommDevices

This subroutine is called to retrieve the list of COMM_DEVICE_ID's (i.e., communication device) and/or the count of devices detected which other APIs may use to determine further information about each device ID. When called with a NULL pointer for pCommDevices, then the number of items retrieved is returned. The application module 302 preferably allocates (size of(COMM_DEVICE_ID)* number of devices) bytes and passes that buffer to this subroutine in the next call.

CommEng_GetDeviceCaps

This subroutine returns the capabilities of the device specified by DeviceID. This subroutine can be used to determine which device to use based on its type and capabilities.

CommEng_GetDeviceType

This is a helper subroutine, which returns the type of the device specified by DeviceID.

CommEng_GetProtocolCount

This subroutine returns the number of communications protocols registered on the system.

CommEng_GetCommProtocols

This subroutine works similar to the CommEng_GetCommDevices subroutine except that it returns communications protocols instead of communications devices. When called with a NULL pointer for pCommProtocols, the number of registered protocols is returned. Tip Allocation of (sizeof(COMM_PROTOCOL_ID)* Number of Protocols) bytes may be buffered and passed to this subroutine on a subsequent call. The caller can then retrieve the capabilities of each protocol. Note that it is more efficient to call CommEng_GetProtocolCount rather than this subroutine with a NULL pointer for the first parameter.

CommEng_GetProtocolID

This subroutine is called to get a pointer to the COMM_PROTOCOL_ID given a communications protocol enumeration value.

CommEng_GetProtocolCaps

This subroutine retrieves the communication protocol's capability structure, which may then be used to determine the specified protocol's capabilities.

CommEng_CreateChannel

This subroutine is called to allocate a channel. If a configuration structure is supplied then it will be used to configure the channel. Otherwise the channel may be configured as necessary before or after opening.

CommEng_OpenChannel

This subroutine is called to open a channel for sending and/or receiving data, as defined below in Table 1.

TABLE 1

| Parameters | Description |
|---|---|
| ChannelID | The ID of the to open. |
| PRemoteAddress | Remote address to open (if applicable). |
| PLocalAddress | Local address to open (if applicable). |
| CommProtID | Communication protocol ID to use. |
| DeviceID | Device ID with which to open the channel. |
| dwFlags | Channel open flags - to be documented |

CommEng_CloseChannel

This subroutine is called to close an open channel. It may be re-opened if necessary. Note that this subroutine does not de-allocate all resources allocated to an existing channel (CommEng_DestroyChannel's described below, below does that).

CommEng_DestroyChannel

This subroutine is called to de-allocate a channel. If necessary, it will close a channel before destroying it.

CommEng_SetChannelConfig

This subroutine is called to configure a channel's attributes and software protocol stack as necessary, as defined below in Table 2.

TABLE 2

| Parameters | Description |
|---|---|
| ChannelID | The ID of the channel to configure |
| pChanConfig | The configuration information structure. |

CommEng_GetChannelConfig

This subroutine is called to retrieve the channel configuration attributes, as defined below in Table 3.

TABLE 3

| Parameters | Description |
|---|---|
| ChannelID | The ID of the channel of which to get the |
| | configuration information. |
| pChanConfig | The configuration information structure. |

CommEng_PeekMsg

This subroutine allows a user (i.e., application module 302 or comm engine API 402 ) to look at the next message in the queue if there is one. The ppMsg parameter is stuffed with a pointer to an internal message buffer in the comm engine 600, and is treated as read-only and used for peeking only. The CommEng_RecvMsg (see description below) subroutine may be called to remove the message from the buffer. If ppMsg is NULL then the message pointer will not be filled. The subroutine will simply return a code indicating whether or not there is data. If there is a message, then CommEng_Peekmsg will set pbData to a non-zero value. If there is no message, the value pointed to by pbData it will be set to zero.

CommEng_RecvMsg

This subroutine is called to retrieve a message from the message queue. When calling it, the pointer ppMsg gets filled with a pointer to the appropriate message data structure. Message helper subroutines (i.e. message crackers) can be called to extract the appropriate data from each message type. The caller must de-allocate the message by calling CommEng_FreeMsg when they are finished with it.

CommEng_Send

This subroutine is called to send data, and is defined below in Table 4. If queue buffering is not enabled for the associated session (i.e., in pass-through mode), then the message is simply sent out (after optionally being processed by data filters in the channel's protocol stack). Otherwise, the data is placed onto the appropriate send queue and processed at the appropriate time. When the message is processed, it is sent through the channel's software protocol stack and then eventually to the device layer 450. Internally, in pass-through mode, if the channel is configured to use a protocol stack, then a COMM_MSG structure is allocated and the data is filtered through the protocol stack's data filter protocols.

TABLE 4

| Parameters | Description |
|---|---|
| ChannelID | Channel ID through which to send the data. |
| pDestAddress | Destination address (if applicable) |
| dwDataSize | The size of the data buffer |
| pvData | Points to a buffer of data to send. |
| dwSendFlags | Send flag may be any combination of the |
| | following: |
| | COMMDVC_SND_NOFLAGS |
| | COMMDVC_SEND_BROADCAST |
| pMsgFlags | Points to a structure containing flags for this |
| | particular message to be sent. These flags |
| | specify settings for the software protocol stack |
| | as well as priority, timeout, etc. See the |
| | description of the COMM_MSG_FLAGS |
| | structure below. If pMsgFlags is NULL then |
| | the default configuration of the protocol stack |
| | is used. |

CommEng_SendMsg

This subroutine can be used to send an existing message. This subroutine is useful when the user wants to send a custom message type or when a received message is to be echoed or forwarded.

CommEng_Peek

This subroutine is a pass-through subroutine to the device layer's COMM_Peek API subroutine, as defined below in Table 5. However, if a channel has been closed from the remote end, it is not always possible for the CommEng_Peek to detect this. Sometimes, the subroutine will return successfully that there is data, but the data happens to be the fact that the channel was closed remotely. Therefore, a send or receive operation on the channel will then cause the disconnection to be detected.

TABLE 5

| Parameters | Description |
|---|---|
| ChannelID | The channel on which to peek for data. |
| pbDataAvail | On return, a non-zero value specifies that there is |
| | data available. It is zero otherwise. |
| dwFlags | Peek flags may be any combination of the |
| | following: |
| | COMMDVC_PEEK_DATATORECV |
| | COMMDVC_PEEK_CONNTOACCEPT |
| | COMMDVC_PEEK_OPENCONNECTION |
| | COMMDVC_PEEK_WAIT_FOR EVER |

CommEng_Recv

This subroutine is called to receive data directly on a channel, as defined below in Table 6. It will block until there is data to be received or the timeout occurs (as per the channel's configuration) so the caller must handle the possibility that it doesn't return right away. If the receiving channel (i.e., ChannelID) is configured with a protocol stack, then the data is processed up through the protocol stack before being returned to the caller. Unless the API is being used as a pass-through to the device layer, the caller should use to CommEng_RecvMsg to retrieve data and messages asynchronously. It should be noted that the user must de-allocate the data buffer returned since this subroutine will allocate the data and return a pointer to that data.

TABLE 6

| Parameters | Description |
|---|---|
| ChannelID | ID of the channel from which to receive data. |
| pSrcAddress | The source address of the received data (if |
| | applicable). |
| dwBufferSize | The size of the buffer pointed to by pvData. |
| pvData | The address of user allocated buffer. |
| pdwRecvDataSize | Filled with the size of the data read. |
| dwRecvFlags | Receive flags may be any combination of the |
| | following: |
| | COMMDVC_RECV_NOFLAGS |
| | COMMDVC_RECV_GETSRCADDR |

CommEng_AcceptConnection

Calling this subroutine allows a channel to wait for a connection. This is to be used in pass-through mode and with a connection oriented protocol only.

CommEng_DoSynchronousWork

When in synchronous mode, the user must call this subroutine to allow the comm engine 600 to perform its tasks. The user must ensure that this subroutine is called frequently enough to handle the amount of data that needs to be sent and/or received.

CommEng_AllocMsg

This subroutine allocates a message based on the input parameters, as defined below in Table 7.

TABLE 7

| Parameters | Description |
|---|---|
| ppMsg | Pointer which is filled with the address of the new |
| | msg. |
| dwDataSize | Size of the data pointed to by pvData. |
| pvData | Address of data buffer to use as the source of the |
| | message. |

CommEng_FreeMsg

This subroutine frees (i.e., returns to internal Msg pool) the message structure specified by the pointer.

CommEng_IsError

This subroutine will return non-zero if eErrorCode is an error, or zero otherwise. Additionally, if eErrorCode is an error, in debug mode, it will print out the error message's text description and the szFunctionName parameter so that the debug output contains the name of the subroutine that detected the error.

CommEng_IsProtocolSupported

This subroutine returns non-zero if the specified device (DeviceID) supports the device protocol indicated by ProtocolID.

The channel manager 416 module interface functionality and associated subroutines will next be discussed in more detail.

ChanMan_CreateChannel

This subroutine creates a channel structure and initializes it appropriately based on the flags specified. Additionally, the channel is added to the appropriate session's channel list. This is called by the CommEng_CreateChannel API subroutine to actually create the channel structure since the channel manager 416 hides the implementation.

ChanMan_OpenChannel

This subroutine actually opens the channel. A channel must be opened before it can be used to send or receive data. This is called by the CommEng_OpenChannel API subroutine.

ChanMan_InitChannelFromID

This subroutine initializes a comm engine 600 channel based on the device layer channel ID and address information.

ChanMan_CloseChannel

This subroutine is called to close a channel. Note that its resources are not de-allocated but rather, the channel is placed into an inactive mode. This is called either internally when a channel is closed implicitly or it is called via the CommEng_CloseChannel API subroutine.

ChanMan_DestroyChannel

This subroutine destroys the specified channel and ensures that any necessary cleanup is performed. The cleanup includes removing the channel from the appropriate session's channel list. This subroutine is called whenever a channel's resources must be de-allocated such as when the corresponding session shuts down or the channel is no longer needed. If the channel is still open, this subroutine will call the CommEng_CloseChannel subroutine to close it first before destroying it. This ensures that any reference counts are valid regardless of how a channel is destroyed.

ChanMan_InitChannelList

This subroutine creates and initializes the channel list for the specified session. Since the implementation of the channel list is hidden from the session manager 418 by the channel manager 416, this subroutine is called to initialize the channel list.

ChanMan_DestroyChannelList

This subroutine destroys the channel list for the specified session.

ChanMan_ProcessSend

The send subroutine calls the appropriate protocol stack's send subroutine to do the actual processing (if necessary) and sending of the data or message. The message queue manager 452 will call this subroutine when it processes the send queues. When something is to be sent, the ChanMan_ProcessSend subroutine is ultimately called. This subroutine pushes the data through its protocol stack and then proceeds to send it down to the device layer 450.

ChanMan_ProcessRecv

The ChanMan_ProcessRecv subroutine is called to process the message received before placing the message onto the queue to be retrieved or peeked by the library user. The subroutine may be called to pull a message from the protocol stack which is then placed onto the channel's receive queue by the caller. However, the protocol stack may have it's own receive queue, in which case this subroutine is called directly by the CommEng_RecvMsg API subroutine. When something comes in from the device layer 450, ChanMan_ProcessRecv is called to process the data before being placed onto the message queue.

ChanMan_DoAsyncWork

This subroutine is the entry point to a channel's protocol stack tick subroutine. This subroutine is called by the session manager 418 to allow each channel a chance to do it's processing.

A channel configuration manager manages configuring the channel to use a specific device, device protocol, and a software protocol stack. It is mainly driven by the channel manager 416 to perform tasks on a channel's configuration substructure or by the comm engine 600 to configure a channel.

Each channel has its own channel specific configuration. This configuration includes a software protocol stack, the device with which it is associated, the device protocol being utilized to transport the data, and other attributes such as whether it is opened in send, receive, or send and receive mode.

The channel configuration manager's module API includes functions to enable the following: add/remove protocols to a channel's protocol stack; set the device protocol to use (this may be changeable at runtime via the channel manager 416 by saving the attributes that are needed to create the channel, closing the device layer channel, opening another device layer using the new device protocol, and setting the current Comm_channel's device layer channel ID to the newly created channel ID in the device layer); set the device to use; and set or change other attributes.

ChanCfg_DestroyChanCfg

The channel manager 416 calls this subroutine to de-allocate the configuration data for a channel.

ChanCfg_CopyChannelCfg

This helper subroutine copies the data from the source channel configuration structure to the destination structure.

The session manager 418 manages sessions and session specific data such as notification methods and channel lists. Each session has its own notification methods, channel lists, and session specific data and configurations of the library.

The session manager 418 drives the rest of the library including the channel manager 416 and message queue manager 452. The channel manager 416 manages the sessions' channel lists. The message queue manager 452 manages the global comm engine 600 message queues.

A callback subroutine is registered with the device layer 450 to handle messages that are received. When a message is received, it is placed onto the receive queue (via a call to the message queue manager 452 ) and then the user is notified using the appropriate notification method set up for that particular session.

The session manager module interface functionality and associated subroutines will next be discussed in more detail.

SessMan_StartUp

This subroutine starts up the session manager 418. All one-time initialization is done here.

SessMan_ShutDown

When called, this subroutine shuts down the session manager 418 and all resources used by the session are cleaned up.

SessMan_AddSession

This subroutine creates and initializes a session, including all necessary allocations of data specific to a session.

SessMan RemoveSession

This subroutine destroys a session and performs any necessary cleanup for the specified session.

SessMan_SetConfig

This subroutine allows the user to configure a session by state.

SessMan_GetConfig

This subroutine retrieves the current session state configuration.

SessMan_SetNotificationMethod

This subroutine sets the notification method and data for the specified session.

SessMan_DoSynchronous

This subroutine allows the session manager 418 to perform any necessary synchronous work. This subroutine in turn allows the channel manager 416 to perform synchronous work on the appropriate channels if necessary.

The message queue manager 452 manages the comm engine 600 message queues. The session manager 418 drives the message queue manager 452 via its module interface. The architecture for the message queue manager 452 is very simple: it inserts messages into the appropriate queue based on priority. When messages are received via the callback subroutine registered with the device layer 450, the message queue manager 452 processes the message via the channel's protocol stack and then places the message onto the appropriate queue. When messages are sent via the comm engine 600 send subroutine (e.g., CommEng_SendMsg), the message is placed onto the send queue based on its priority. When the message queue manager 452 processes the send queues, it calls the channel manager's 404 send subroutine (e.g., ChanMan_Send) to perform the actual send through the protocol stack.

The message queue manager 452 module interface functionality and associated subroutines will next be discussed in more detail.

MQMan_Startup

The startup subroutine creates and initializes the message queues.

MQMan_Shutdown

The shutdown subroutine destroys all queues and cleans-up after itself.

MQMan_InitChannelQueue

This subroutine initializes the specified channel's receive message queue.

MQMan_DeInitChannelQueue

This subroutine cleans up the specified channel's receive message queue.

MQMan_InsertSendMsg

This subroutine inserts a message onto the appropriate send queue based on priority. This will be called most often from the mechanism that handles sending and receiving data. This mechanism will be done through the session manager 418.

MQMan_ProcessSendQueues

This subroutine is called by the session manager 418 to process all the messages in the send queues. Essentially, this subroutine traverses the send queues, de-references the channel pointer, and calls the channel's send subroutine.

MQMan_FlushSendQueue

This subroutine flushes the specified message queue. Queued messages may be processed or discarded.

MQMan_InsertRecvMsg

This subroutine inserts a message onto the proper channel receive queue. The session manager 418 calls this subroutine whenever it receives a message via the callback subroutine registered with the device layer 450.

MQMan_PeekMsg

This subroutine returns a pointer to the next message for the specified channel.

MQMan_RemoveMsg

This subroutine removes the message from the specified channel's receive queue. If the message pointer itself is not specified, then whatever message is at the head of the specified channel's receive queue is removed.

MQManFlushRecvQueue

This subroutine flushes the specified channel's receive queue.

The CPC 302 provides the following functionality: a cross platform ANSI (American National Standards Institute) C library; standard types across platforms and compilers; support for standardized compiler features, platforms types, Unicode; a cross platform Hardware Emulation Layer; and release and debug options. The CPC 302 may be operable in connection with the following hardware platforms (provided by way of non-limiting example): Windows 95/98/ NT 4.0/2000; Windows CE for Dreamcast; Shinobi for Dreamcast; Linux (Red hat 5.1/5.2/6.0/6.1 ); and Playstation 2. It will be obvious to persons skilled in the art, and from the disclosure provided herein, that other hardware platforms are contemplated by and within the scope and spirit of the present invention. Thus, the previously mentioned hardware platforms are merely illustrative, non-limiting examples. Supported hardware platforms may be defined in file such as, for example, C_targets.h.

Unicode is a standard for representing characters as integers. Unlike ASCII, which uses 8 bits for each character, Unicode uses 16 bits, which means that it can represent more than 65,000 unique characters. This may be unnecessary English-language and Western-European-language programs (i.e., computer games), but it may be necessary for some other languages, such as Greek, Chinese and Japanese. As the software industry becomes increasingly global, Unicode may eventually supplant ASCII as the standard character-coding format. The CPC 320 may include macros for converting he ASCII to Unicode, and vice versa.

Thus, while there have been shown and described and pointed out fundamental novel features of the invention as applied to preferred embodiments thereof, it will be understood that various omissions and substitutions and changes in the form and details of the disclosed invention may be made by those skilled in the art without departing from the spirit of the invention. It is the intention, therefore, that the present invention be limited only as indicated by the scope of the claims appended hereto.

What is claimed is:

1. A computer readable medium comprising computer code operable in connection with a processor of a computer having a data storage device and having an operating system stored thereon, the computer including a hardware device and a communication device, said computer readable medium comprising computer code for:
providing an application module; and
providing an interface to facilitate communication between said application module and any operating system, including the operating system.

2. A computer readable medium as recited by claim 1, wherein said interface for facilitates communication between said application module and any hardware device, including the hardware device.

3. A computer readable medium as recited by claim 2, wherein said interface further facilitates communication between said application module and any communication device, including the communication device.

4. A computer readable medium as recited by claim 1, wherein said interface comprises a cross-platform core.

5. A computer readable medium as recited by claim 1, wherein said interface comprises a communications engine comprising:
a communications engine API in communication with said application module;
a service layer in communication with said communications engine API; and
a device layer in communication with said service layer and with the hardware device and communication device.

6. A computer readable medium as recited by claim 5, wherein said service layer comprises a hardware emulation layer that forwards hardware implement calls from said application module to said device layer and that is capable of providing hardware emulation to said application module.

7. A computer readable medium as recited by claim 6, wherein said service layer further comprises:
a channel manager for managing a list of channels for a session;
a session manager for causing said channel manager to perform an operation on said list of channels; and
a message queue manager for managing the comm engine message queues.

8. A computer readable medium as recited by claim 1, wherein said application module comprises a multi-player computer game.

9. A computer readable medium as recited by claim 1, wherein said interface enables communication between the computer and another computer, and wherein a user of the computer may play said multi-player computer game against a user of the another computer.

10. A multi-player computer game system comprising a server having a data storage device and having special purpose software stored thereon and operable in connection with a processor of said server, said special purpose software enabling multi-player computer game play between a user of a first computer and a user of a second computer over a network, the first computer having a data storage device and having a first operating system stored thereon and further having special purpose software stored thereon and operable in connection with a processor of the first computer, the second computer having a data storage device and having a second operating system stored thereon and further having special purpose software stored thereon and operable in connection with a processor of the second computer, wherein one of the first operating system and the second operating system, or one of the first computer and the second computer, are different from each other.

11. A multi-player computer game system as recited by claim 10, wherein said server comprises a plurality of servers in communication with each other and each providing a predetermined functionality.

12. A multi-player computer game system as recited by claim 11, wherein said plurality of servers comprise a web server, a match maker server, a resource server, a user identification server, a chat server, a tournament server, a ranking server, an ideal service finder, a domain name server, and a game server.

13. A multi-player computer game system as recited by claim 12, wherein the special purpose software installed on each of the first and second computers provides a subset of the functionality provided said plurality of servers.

14. A multi-player computer game system as recited by claim 10, wherein said special purpose software controls multi-player computer game play between the user of the first computer and the user of the second computer over the network.

15. A multi-player computer game system as recited by claim 10, wherein said special purpose software partially controls multi-player computer game play between the user of the first computer and the user of the second computer over the network.

16. A multi-player computer game system comprising:
a first computer having a data storage device and having special purpose software stored thereon and operable in connection with a processor of said first computer, said first computer having a data storage device and having a first operating system stored thereon and operable in connection with said processor of said first computer; and
a second computer having a data storage device and having special purpose software stored thereon and operable in connection with a processor of said second computer, said second computer having a data storage device and having a second operating system stored thereon and operable in connection with said processor of said second computer;
said special purpose software on said first and said second computers enabling multi-player computer game play between a user of said first computer and a user of said second computer over a network, wherein one of said first computer and said second computer, or one of said first operating system and said second operating system are different from each other.

17. A multi-player computer game system as recited by claim 16, wherein said each of said first and said second computer further comprises a first and second hardware device and a first and second communication device, said wherein said special purpose software on each of said first and said second computer is a multi-player computer game comprising:
an application module; and
an interface to facilitate communication between said application module and any operating system, including each of said first and said second operating system.

18. A multi-player computer game system as recited by claim 17, wherein said interface further facilitates communication between said application module and any hardware device, including each of said first and said second hardware device.

19. A multi-player computer game system as recited by claim 18, wherein said interface further facilitates communication between said application module and any communication device, including each of said first and said second communication device.

20. A multi-player computer game system as recited by claim 17, wherein said interface comprises a cross-platform core.

21. A multi-player computer game system as recited by claim 17, wherein said interface comprises a communications engine comprising:
a communications engine API in communication with said application module;
a service layer in communication with said communications engine API; and
a device layer in communication with said service layer and with the hardware device and communication device.

22. A multi-player computer game system as recited by claim 21, wherein said service layer comprises a hardware emulation layer that forwards hardware implement calls from said application module to said device layer and that is capable of providing hardware emulation to said application module.

23. A multi-player computer game system as recited by claim 22, wherein said service layer further comprises:
a channel manager for managing a list of channels for a session;
a session manager for causing said channel manager to perform an operation on said list of channels; and
a message queue manager for managing a message queue of said communications engine.

24. A multi-player computer game development method for developing a multi-player computer game installable on a data storage device of a computer and operable in connection with a processor of the computer, an operating system being installed on the data storage device and operable in connection with the processor, said method comprising the step of providing an interface to facilitate communication between an application module and more than one operating system.

25. A multi-player computer game development method as recited by claim 24, wherein said interface facilitates communication between the application module and more than one hardware device, including the hardware device.

26. A multi-player computer game development method as recited by claim 25, wherein said interface further facilitates communication between said application module and any communication device, including the communication device, including the communication device.

27. A multi-player computer game development method as recited by claim 24, wherein said interface comprises a cross-platform core.

28. A multi-player computer game development method as recited by claim 24, wherein said interface comprises a communications engine comprising:
a communications engine API in communication with the application module;
a service layer in communication with said communications engine API; and
a device layer in communication with said service layer and with the hardware device and communication device.

29. A multi-player computer game development method as recited by claim 28, wherein said service layer comprises a hardware emulation layer that forwards hardware implement calls from said application module to said device layer and that is capable of providing hardware emulation to said application module.

30. A multi-player computer game development method as recited by claim 29, wherein said service layer further comprises:
a channel manager for managing a list of channels for a session;
a session manager for causing said channel manager to perform an operation on said list of channels; and
a message queue manager for managing the comm engine message queues.

31. A multi-player computer game development method as recited by claim 24, wherein the application module comprises a multi-player computer game.
